(19) United States
(12) Patent Application Publication
(10) Pub. No.: US 2024/0049166 A1
(43) Pub. Date: Feb. 8, 2024

(54) TERRESTRIAL POSITIONING FOR UNKNOWN CELLS

(71) Applicant: QUALCOMM Incorporated, San Diego, CA (US)

(72) Inventors: Grant MARSHALL, Campbell, CA (US); Ie-Hong LIN, Cupertino, CA (US)

(21) Appl. No.: 18/349,092

(22) Filed: Jul. 7, 2023

Related U.S. Application Data
(60) Provisional application No. 63/369,870, filed on Jul. 29, 2022.

(51) Int. Cl. H04W 64/00

(52) U.S. Cl. CPC H04W 64/003

(57) ABSTRACT

Aspects presented herein relate to methods and devices for wireless communication including an apparatus, e.g., a device or a server. The apparatus may detect a set of cells associated with a network node, where each of the set of cells includes a cell ID, where the cell ID for each of the set of cells is associated with a node ID for the network node. The apparatus may also identify a location of each of the set of cells based on the cell ID for each of the set of cells. Additionally, the apparatus may estimate an average location of the set of cells based on the location of each of the set of cells. The apparatus may also calculate a location of the network node based on the average location of the set of cells.

### CROSS REFERENCE TO RELATED APPLICATION(S)

This application claims the benefit of and priority to U.S. Provisional Application Ser. No. 63/369,870, entitled “TERRESTRIAL POSITIONING FOR UNKNOWN CELLS” and filed on Jul. 29, 2022, which is expressly incorporated by reference herein in its entirety.

### TECHNICAL FIELD

The present disclosure relates generally to communication systems, and more particularly, to positioning measurements in wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be an apparatus for wireless communication at a device or a user equipment (UE). The apparatus may transmit, to a network entity, a request for a location of a network node associated with a set of cells, where each of the set of cells includes a cell identifier (ID), where the cell ID for each of the set of cells is associated with a node ID for the network node. The apparatus may also receive, from the network entity based on the request, an indication of the location of the network node associated with the set of cells, where the location of the network node is based on an average location of the set of cells.

In an aspect of the disclosure, a method, a computer-readable medium, and an apparatus are provided. The apparatus may be an apparatus for wireless communication at a server or a network entity. The apparatus may receive, from at least one device, a request for a location of a network node prior to a detection of a set of cells associated with the network node; and transmit, for the at least one device based on the request, an indication of a location of the network node after a calculation of a location of the network node. The apparatus may also detect a set of cells associated with a network node, where each of the set of cells includes a cell identifier (ID), where the cell ID for each of the set of cells is associated with a node ID for the network node. The apparatus may also identify a location of each of the set of cells based on the cell ID for each of the set of cells. Moreover, the apparatus may crowdsource data for each of the set of cells associated with each of the plurality of coverage areas; and determine a location of the coverage area for each of the set of cells based on the crowdsourced data, where the location of each of the set of cells is identified based on the location of the coverage area. The apparatus may also estimate an average location of the set of cells based on the location of each of the set of cells. The apparatus may also calculate a location of the network node based on the average location of the set of cells. Further, the apparatus may calculate a location of at least one cell based on the average location of the set of cells, where the at least one cell is at least one unknown cell associated with the set of cells. The apparatus may also output an indication of the location of the network node based on the calculation the location of the network node.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a wireless communication system.

FIG. 6 is a diagram illustrating an example positioning procedure.

FIG. 7 is a diagram illustrating an example cell grouping for a wireless communication system.

FIG. 8 is a diagram illustrating an example cell grouping for a wireless communication system.

FIG. 9 is a diagram illustrating example ranges for a base station and corresponding cells in a wireless communication system.

FIG. 10 is a diagram illustrating example ranges for a base station and corresponding cells in a wireless communication system.

FIG. 11 is a communication flow diagram illustrating example communications between a device and a server.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

FIG. 18 is a diagram illustrating an example of a hardware implementation for an example network entity.

### DETAILED DESCRIPTION

In aspects of wireless communication, certain types of cells (e.g., network cells) may be associated with network nodes or base stations (e.g., a gNB in 5G NR or an eNB in LTE). For example, cells may be grouped at different network nodes or base stations. These cells may be a number of different types of cells (e.g., transmission-reception point (TRP), a small cell, a small cell base station, or a user equipment (UE)). In some aspects, a base station (BS) identifier (ID) (e.g., eNB ID or gNB ID) may be used to identify base stations within a certain network (e.g., a public land mobile network (PLMN)). The base station ID may be contained within the cell identity (CI) of its cells. A global base station ID (e.g., global eNB ID or global gNB ID) may be used to identify base stations globally. The global base station ID may be constructed from the PLMN identity to which the base station belongs and/or the base station ID. A mobile country code (MCC) and a mobile network code (MNC) may be included in a certain cell global identifier (e.g., an E-UTRAN cell global identifier (ECGI)). Additionally, there may be a number of different types of base station IDs (e.g., gNB ID or eNB ID). For instance, a macro base station ID (e.g., macro eNB ID or macro gNB ID) may be equal to a number of leftmost bits (e.g., 20 leftmost bits) of a cell identity information element (IE) contained in a cell global identifier (CGI) information element (IE) (e.g., E-UTRAN CGI IE) of each cell served by the base station (e.g., gNB or eNB). A home base station ID (e.g., a home eNB ID or home gNB ID) may be equal to a cell identity IE contained in the CGI IE (e.g., an E-UTRAN CGI IE) of each cell served by the base station (e.g., gNB or eNB). Also, a short macro base station ID (e.g., short macro eNB ID or short macro gNB ID) may be equal to a number of leftmost bits (e.g., 18 leftmost bits) of a cell identity IE of each cell served by the base station (e.g., gNB or eNB). Further, a long macro base station ID (e.g., long macro eNB ID or long macro gNB ID) may be equal to a number of leftmost bits (e.g., 21 leftmost bits) of a cell identity IE of each cell served by the base station (e.g., gNB or eNB), where the long macro base station ID is longer than the short macro base station ID. In some aspects, recent or new networks (e.g., new LTE networks or new NR networks), such as narrowband Internet of Things (NB-IoT), may not have enough observations to create a crowdsourced database. Also, terrestrial position techniques which compare device-observed cell identifiers to a crowdsource database may fail for new networks, as there has not been significant crowdsourcing yet to collect all of the network cells. However, as a new air interface (e.g., a new NB-IoT air interface) may be deployed on existing networks (e.g., existing LTE or NR networks), certain techniques may be used to perform positioning for observed cells (e.g., NB-IoT cells). Aspects of the present disclosure may perform positioning measurements for cells that do not otherwise exist in a database. In some instances, aspects presented herein may also perform positioning measurements for cells when a crowdsourced database already exists. Additionally, aspects presented herein may perform crowdsourcing (e.g., crowdsourcing on-the-fly) for cells that do not otherwise exist in a database (or for cells when a crowdsourced database already exists). In order to do so, aspects presented herein may utilize servers or network entities that detect and identify a location of a set of cells associated with a network node or a base station. For instance, servers or network entities may identify a location of each cell based on the cell ID for each cell. Also, servers or network entities may estimate an average location of the cells based on the location of each of the cells, and then calculate a location of the base station or network node based on the average location of the cells. Moreover, aspects presented herein may utilize terrestrial positioning services that provide wide and complete location data for cells in certain types of networks (e.g., NB-IoT, CAT-M1, or LTE networks). In some instances, aspects presented herein may infer unknown cell positions from database information (e.g., LTE database information).

Particular aspects of the subject matter described in this disclosure can be implemented to realize one or more of the following potential advantages. That is, aspects of the present disclosure may include a number of benefits or advantages. For instance, aspects presented herein may allow for new cells that cannot be found in a database based on their cell ID (because they have not been crowdsourced), to be associated with base stations, and the computed base station position may be used for terrestrial position estimate for the cell. Furthermore, the results of this association at the server or network entity may be saved and seeded back into the database as a form of coarse crowdsourcing. As a result, this can help to build a new database. This database can be updated/replaced by true GNSS-aided crowdsourcing later as the device population increases. The seeded database may be used for both single-cell and multi-cell terrestrial positioning. As such, aspects presented herein may provide positioning and crowdsourcing for cells that do not otherwise exist in a database.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

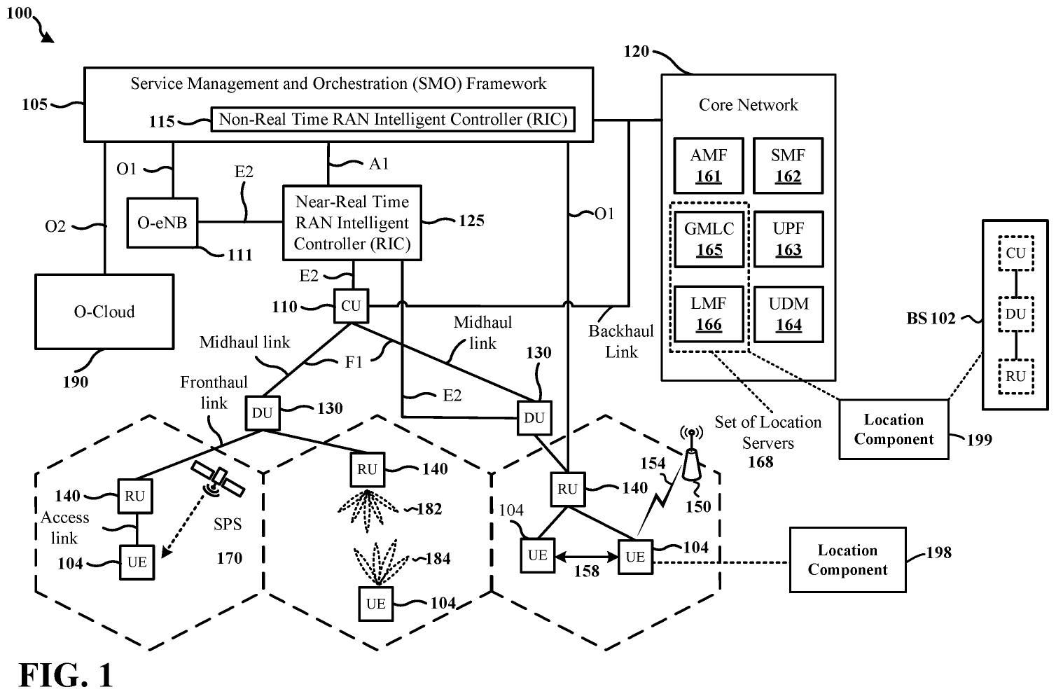

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network. A network node can be implemented as a base station (i.e., an aggregated base station), as a disaggregated base station, an integrated access and backhaul (IAB) node, a relay node, a sidelink node, etc. A network entity can be implemented as a base station (i.e., an aggregated base station), or alternatively, as a central unit (CU), a distributed unit (DU), a radio unit (RU), a Near-Real Time (Near-RT) RAN Intelligent Controller (RIC), or a Non-Real Time (Non-RT) RIC in a disaggregated base station architecture.

Referring again to FIG. 1, in certain aspects, the UE 104 may include a location component 198 that may be configured to transmit, to a network entity, a request for a location of a network node associated with a set of cell, where each of the set of cells includes a cell identifier (ID), where the cell ID for each of the set of cells is associated with a node ID for the network node. Location component 198 may also be configured to receive, from the network entity based on the request, an indication of the location of the network node associated with the set of cells, where the location of the network node is based on an average location of the set of cells.

In certain aspects, the base station 102 and/or LMF 166 may include a location component 199 that may be configured to receive, from at least one device, a request for a location of a network node prior to a detection of a set of cells associated with the network node; and transmit, for the at least one device based on the request, an indication of a location of the network node after a calculation of a location of the network node. Location component 199 may also be configured to detect a set of cells associated with a network node, where each of the set of cells includes a cell identifier (ID), where the cell ID for each of the set of cells is associated with a node ID for the network node. Location component 199 may also be configured to identify a location of each of the set of cells based on the cell ID for each of the set of cells. Location component 199 may also be configured to crowdsource data for each of the set of cells associated with each of the plurality of coverage areas; and determine a location of the coverage area for each of the set of cells based on the crowdsourced data, where the location of each of the set of cells is identified based on the location of the coverage area. Location component 199 may also be configured to estimate an average location of the set of cells based on the location of each of the set of cells. Location component 199 may also be configured to calculate a location of the network node based on the average location of the set of cells. Location component 199 may also be configured to calculate a location of at least one cell based on the average location of the set of cells, where the at least one cell is at least one unknown cell associated with the set of cells. Location component 199 may also be configured to output an indication of the location of the network node after the calculation of the location of the network node. Although the following description may be focused on 5G NR, the concepts described herein may be applicable to other similar areas, such as LTE, LTE-A, CDMA, GSM, and other wireless technologies.

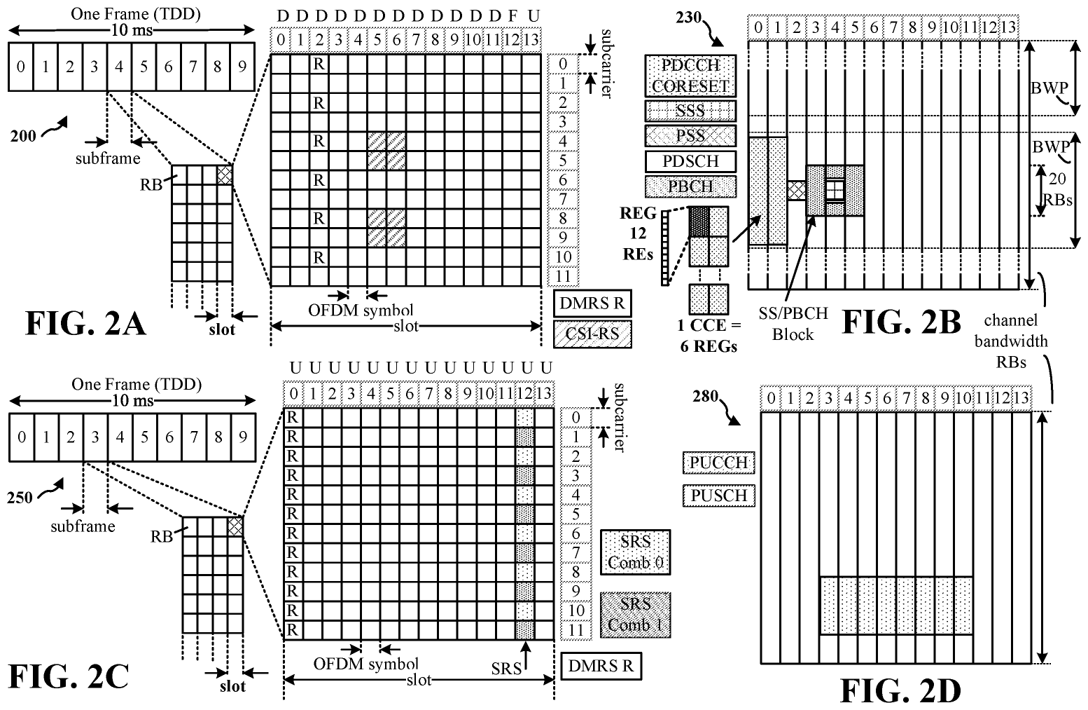

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

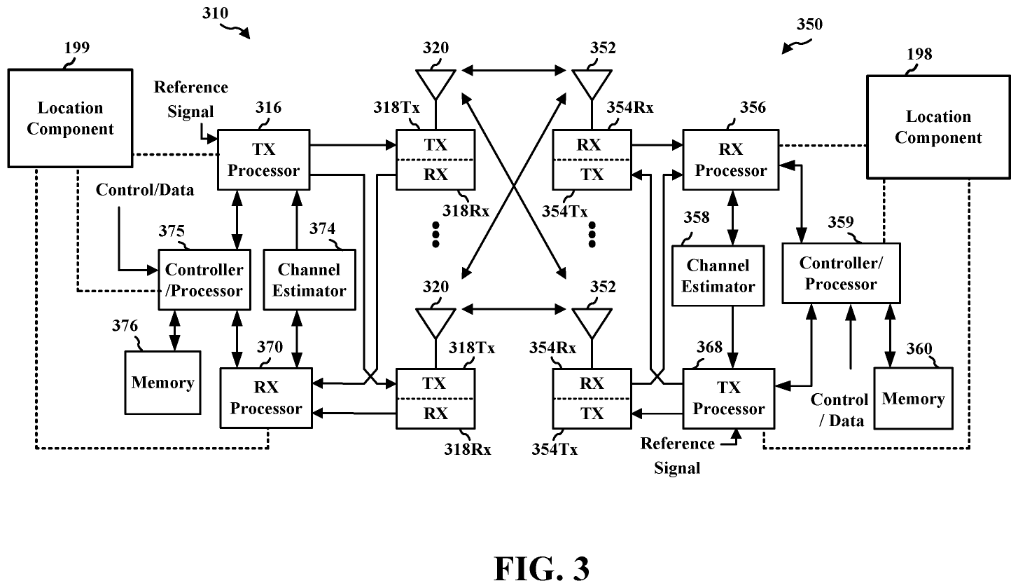

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the location component 198 of FIG. 1. At least one of the TX processor 316, the RX processor 370, and the controller/processor 375 may be configured to perform aspects in connection with the location component 199 of FIG. 1.

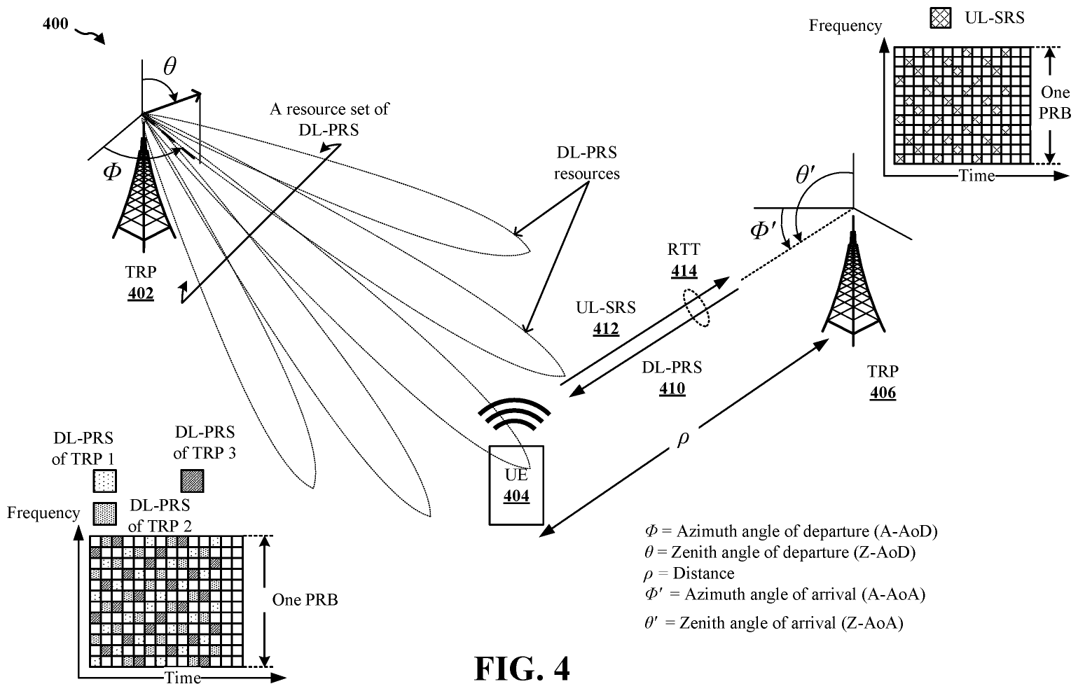

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406. DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404. UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

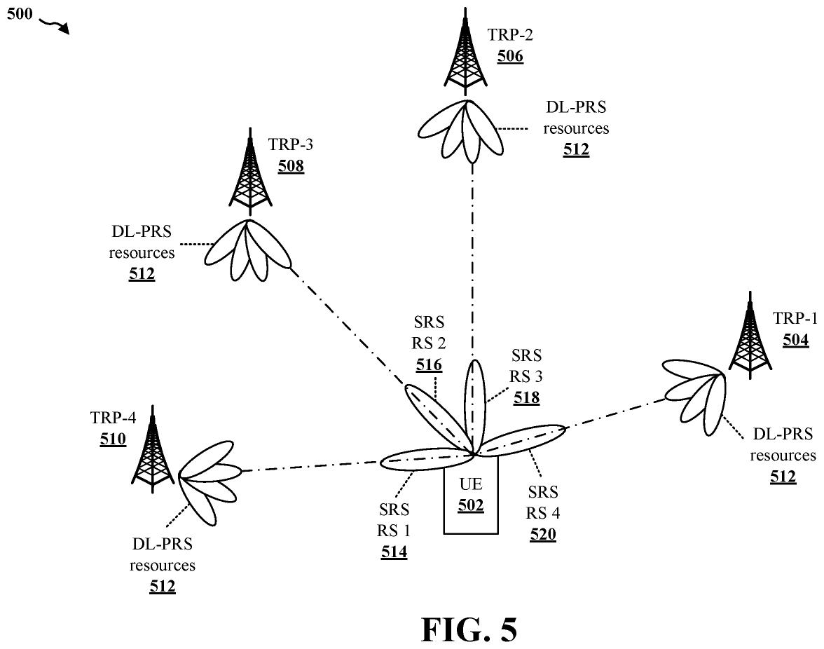

FIG. 5 is a diagram 500 illustrating an example of estimating a position of a UE based on multi-RTT measurements from multiple TRPs in accordance with various aspects of the present disclosure. A UE 502 may be configured by a serving base station to decode DL-PRS resources 512 that correspond to and are transmitted from a first TRP 504 (TRP-1), a second TRP 506 (TRP-2), a third TRP 508 (TRP-3), and a fourth TRP 510 (TRP-4). The UE 502 may also be configured to transmit UL-SRSs on a set of UL-SRS resources, which may include a first SRS resource 514, a second SRS resource 516, a third SRS resource 518, and a fourth SRS resource 520, such that the serving cell(s), e.g., the first TRP 504, the second TRP 506, the third TRP 508, and the fourth TRP 510, and as well as other neighbor cell(s), may be able to measure the set of the UL-SRS resources transmitted from the UE 502. For multi-RTT measurements based on DL-PRS and UL-SRS, as there may be an association between a measurement of a UE for the DL-PRS and a measurement of a TRP for the UL-SRS, the smaller the gap is between the DL-PRS measurement of the UE and the UL-SRS transmission of the UE, the better the accuracy may be for estimating the position of the UE and/or the distance of the UE with respect to each TRP.

In some aspects of wireless communication, the terms “positioning reference signal” and “PRS” may generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. In some aspects, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

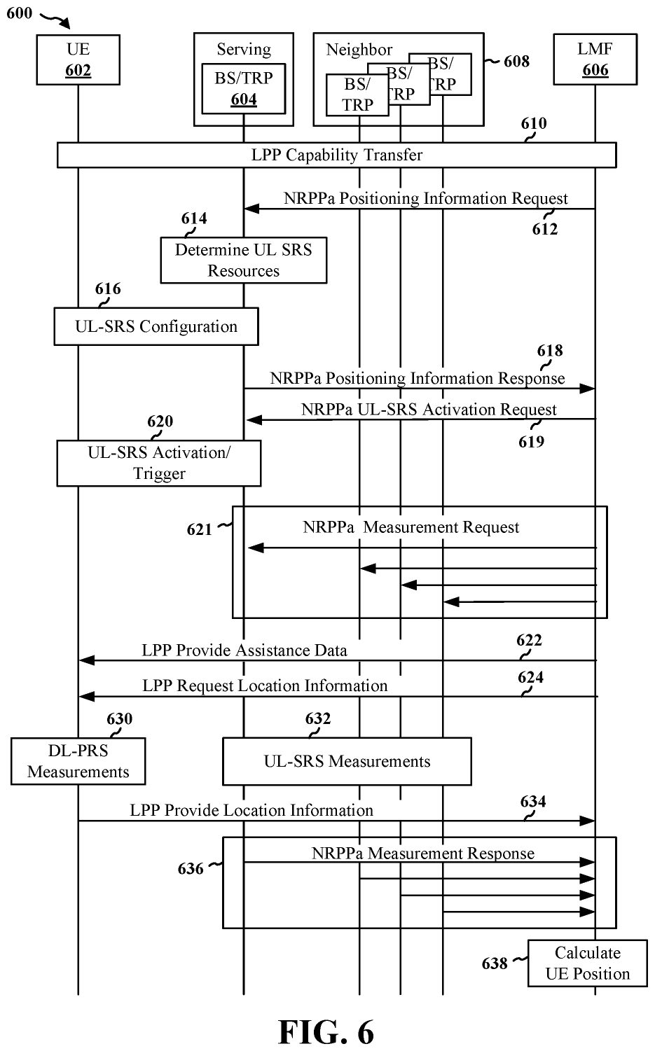

FIG. 6 is a communication flow 600 illustrating an example multi-RTT positioning procedure in accordance with various aspects of the present disclosure. The numberings associated with the communication flow 600 do not specify a particular temporal order and are merely used as references for the communication flow 600. In addition, a DL-only and/or an UL-only positioning may use a subset or subsets of this multi-RTT positioning procedure.

At 610, an LMF 606 may request one or more positioning capabilities from a UE 602 (e.g., from a target device). In some examples, the request for the one or more positioning capabilities from the UE 602 may be associated with an LTE Positioning Protocol (LPP). For example, the LMF 606 may request the positioning capabilities of the UE 602 using an LPP capability transfer procedure. At 612, the LMF 606 may request UL SRS configuration information for the UE 602. The LMF 606 may also provide assistance data specified by a serving base station 604 (e.g., pathloss reference, spatial relation, and/or SSB configuration(s), etc.). For example, the LMF 606 may send an NR Positioning Protocol A (NRPPa) positioning information request message to the serving base station 604 to request UL information for the UE 602.

At 614, the serving base station 604 may determine resources available for UL SRS, and at 616, the serving base station 604 may configure the UE 602 with one or more UL SRS resource sets based on the available resources. At 618, the serving base station 604 may provide UL SRS configuration information to the LMF 606, such as via an NRPPa positioning information response message. At 619, for semi-persistent or aperiodic UL SRS, the LMF 606 may request the serving base station 604 to activate/trigger the UL SRS in the UE 602. For example, the LMF 606 may request activation of UE SRS transmission by sending an NRPPa positioning activation request message to the serving base station 604. At 620, the serving base station 604 may activate the UE SRS transmission and send an NRPPa positioning activation response message. In response, the UE 602 may begin the UL-SRS transmission according to the time domain behavior of UL SRS resource configuration. At 621, the LMF 606 may select one or more candidate neighbor BS s/TRPs 608, and the LMF 606 may provide an UL SRS configuration to the one or more candidate neighbor BSs/TRPs 608 and/or the serving base station 604, such as via an NRPPa measurement request message. The message may include information for enabling the one or more candidate neighbor BSs/TRPs 608 and/or the serving base station to perform the UL measurements.

At 622, the LMF 606 may send an LPP provide assistance data message to the UE 602. The message may include specified assistance data for the UE 602 to perform the DL measurements. At 624, the LMF 606 may send an LPP request location information message to the UE 602 to request multi-RTT measurements.

At 630, the UE 602 may perform the DL measurements from the one or more candidate neighbor BS s/TRPs 608 and/or the serving base station 604 provided in the assistance data. At 632, each of the configured one or more candidate neighbor BSs/TRPs 608 and/or the serving base station 604 may perform the UL measurements. At 634, the UE 602 may report the DL measurements to the LMF 606, such as via an LPP provide location information message. At 636, each of the one or more candidate neighbor BS s/TRPs 608 and/or the serving base station 604 may report the UL measurements to the LMF 606, such as via an NRPPa measurement response message. At 638, the LMF 606 may determine the RTTs from the UE 602 and BS/TRP Rx-Tx time difference measurements for each of the one or more candidate neighbor BS s/TRPs 608 and/or the serving base station 604 for which corresponding UL and DL measurements were provided at 634 and 636, and the LMF 606 may calculate the position of the UE 602.

In aspects of wireless communication, a cellular network (i.e., mobile network) may be a telecommunications network including a wireless link to/from different nodes and the network may be distributed over land areas (which may be referred to as cells), where each cell/area is served by at least one fixed-location transceiver. A cell may also be a node or a transceiver that is in communication with other cells in the network. Accordingly, a cell may refer to an area in a network or a node/transceiver in a network. Certain types of cells (e.g., network cells) may be associated with network nodes or base stations (e.g., a gNB in 5G NR or an eNB in LTE). For example, cells may be grouped at different network nodes or base stations. These cells may be a number of different types of cells (e.g., transmission-reception point (TRP), a small cell, a small cell base station, a macro cell, or a macro cell base station). In some aspects, a base station (BS) identifier (ID) (e.g., eNB ID or gNB ID) may be used to identify base stations within a certain network (e.g., a public land mobile network (PLMN)). The base station ID may be contained within the cell identity (CI) of its corresponding cells. A global base station ID (e.g., global eNB ID or global gNB ID) may be used to identify base stations globally. The global base station ID may be constructed from the PLMN identity to which the base station belongs and/or the base station ID. A mobile country code (MCC) and a mobile network code (MNC) may be included in a certain cell global identifier (e.g., an E-UTRAN cell global identifier (ECGI)). A mobile country code may be a code that is used to identify a country for mobile communications. A mobile network code may be a code that is used to identify a network for mobile communications. A physical cell ID may be an identifier (ID) used for identifying a cell from the physical layer signaling.

Additionally, there may be a number of different types of base station IDs (e.g., gNB ID or eNB ID). A macro base station ID may be equal to a number of bits of a cell identity information element (IE). For instance, a macro base station ID (e.g., macro eNB ID or macro gNB ID) may be equal to a number of leftmost bits (e.g., 20 leftmost bits) of a cell identity information element (IE) contained in a cell global identifier (CGI) IE (e.g., E-UTRAN CGI IE) of each cell served by the base station (e.g., gNB or eNB). A home base station ID (e.g., a home eNB ID or home gNB ID) may be equal to a cell identity IE contained in the CGI IE (e.g., an E-UTRAN CGI IE) of each cell served by the base station (e.g., gNB or eNB). Also, a short macro base station ID (e.g., short macro eNB ID or short macro gNB ID) may be equal to a number of leftmost bits (e.g., 18 leftmost bits) of a cell identity IE of each cell served by the base station (e.g., gNB or eNB). Further, a long macro base station ID (e.g., long macro eNB ID or long macro gNB ID) may be equal to a number of leftmost bits (e.g., 21 leftmost bits) of a cell identity IE of each cell served by the base station (e.g., gNB or eNB), where the long macro base station ID may be longer than the short macro base station ID.

In some aspects, recent or new networks (e.g., new LTE networks or new NR networks), such as narrowband Internet of Things (NB-IoT), may not have enough observations to create a crowdsourced database. Crowdsourcing may be the practice of obtaining information or input into a task or project by enlisting the services of a large number of users or participants (e.g., via the Internet). Crowdsourcing may involve a large group of dispersed participants contributing goods/services (e.g., ideas, votes, micro-tasks, and finances). Crowdsourcing may also involve digital platforms to attract and divide work between participants to achieve a cumulative result. Crowdsourcing may be used to obtain different types of data (i.e., crowdsourced data), such as data for obtaining information regarding a wireless communication network. In some instances, terrestrial position techniques which compare device-observed cell identifiers to a crowdsource database may fail for new networks, as there may not have been significant crowdsourcing yet to collect all of the network cells. However, as a new air interface (e.g., a new NB-IoT air interface) may be deployed for existing networks (e.g., existing LTE or NR networks), certain techniques may be used to perform positioning for observed cells (e.g., NB-IoT cells). Based on the above, it may be beneficial to perform positioning measurements for cells that do not otherwise exist in a database (e.g., LTE cells, category M1 (CAT-M1) cells, NB-IoT cells, etc.). It may also be beneficial to perform positioning measurements for cells when a crowdsourced database already exists.

Aspects of the present disclosure may perform positioning measurements for cells that do not otherwise exist in a database. In some instances, aspects presented herein may also perform positioning measurements for cells when a crowdsourced database already exists. Additionally, aspects presented herein may perform crowdsourcing (e.g., crowdsourcing on-the-fly) for cells that do not otherwise exist in a database (or for cells when a crowdsourced database already exists). In order to do so, aspects presented herein may utilize servers or network entities that detect and identify a location of a set of cells associated with a network node or a base station. For instance, servers or network entities may identify a location of each cell based on the cell ID for each cell. A cell identifier or cell ID may help to identify each of the cells in a network. For example, a cell ID may be a number that is used for identification of a cell. Additionally, a node identifier or node ID may help to identify each of the nodes in a network (e.g., network nodes). For example, a node ID may be a number that is used for identification of a node. Also, servers or network entities may estimate an average location of the cells based on the location of each of the cells, and then calculate a location of the base station or network node based on the average location of the cells. An average location may be a mean location of a set of locations of a cell/node (e.g., recent locations of a cell/node). Moreover, aspects presented herein may utilize terrestrial positioning services that provide wide and complete location data for cells in certain types of networks (e.g., NB-IoT, CAT-M1, and/or LTE networks). In some instances, aspects presented herein may infer unknown cell positions from database information (e.g., LTE database information). For instance, aspects presented herein may determine the positions of cells, unknown in a database, from information contained in the database.

In some aspects, new cells (e.g., NB-IoT, CAT-M1, and/or LTE cells) may be deployed on existing base stations (e.g., LTE eNBs). Also, an existing crowdsourced database (e.g., LTE database) may be used to form a position estimate for each base station by finding all the cells belonging to each base station grouped at base station sites. New cells (e.g., NB-IoT cells) that are not found in the database based on their cell identifier (because they have not been crowdsourced) may be associated with base stations, and the computed base station position may be used for a terrestrial position estimate for the user of the cell (e.g., NB-IoT cell). Furthermore, the results of this association at the server or network entity may be saved and seeded (i.e., fed) back into the database as a form of coarse crowdsourcing. As a result, this may help to build a new database (e.g., NB-IoT database). This database may then be updated/replaced by true global navigation satellite system (GNSS)-aided crowdsourcing later as the device (e.g., NB-IoT device) population increases. The seeded database may be used for both single-cell and multi-cell terrestrial positioning. As such, aspects presented herein may provide positioning and crowdsourcing on-the-fly for cells (e.g., LTE-related cells) that do not otherwise exist in the database (e.g., LTE, CAT-M1, or NB-IoT database). That is, aspects presented herein may provide positioning and crowdsourcing on-the-fly for unknown cells or cells without a cell ID in a database.

Additionally, in some aspects, database coverage (e.g., CAT-M1 or NB-IoT database coverage) may be relatively low or sparse, but cells may be inferred from existing databases (e.g., LTE database). As indicated herein, certain cells (e.g., CAT-M1 cells) may be a narrowband feature of LTE cells, and certain cells (e.g., NB-IoT cells) may be deployed on the same base stations (e.g., eNBs) as LTE cells. Further, for CAT-M1, multiple cell (multi-cell) positioning may be available (e.g., leveraging CAT-M1 host LTE cells and non-CAT-M1 LTE cells). For NB-IoT, single-cell positioning may be available without crowdsourcing. Also, for NB-IoT, multi-cell positioning may be available as unknown cells are observed by different devices.

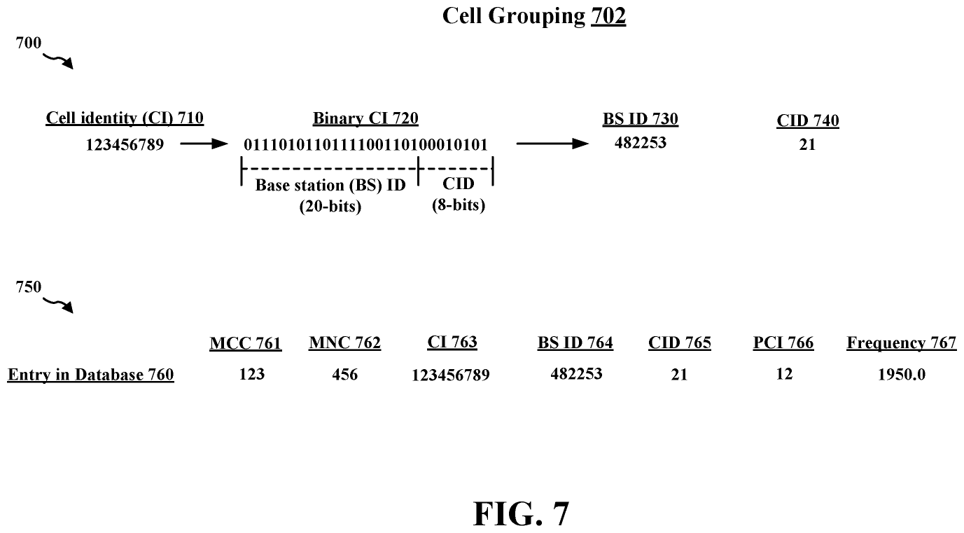

FIG. 7 is a diagram 700 and diagram 750 illustrating an example cell grouping (e.g., cell grouping 702) for a wireless communication system. More specifically, FIG. 7 depicts how a cell ID (CID) may be extracted from a cell identity (CI) in a database. As shown in FIG. 7, diagram 700 includes cell identity 710, binary CI 720, base station ID 730, and CID 740. For instance, cell identity 710 is a 9-digit number (e.g., ‘123456789’), binary CI 720 is a 28-bit number including 20-bits for the base station ID (e.g., base station ID 730) and 8-bits for the CID (e.g., CID 740). Also, diagram 700 depicts that a certain 20-bit base station ID (e.g., an ID equal to ‘01110101101111001101’) may translate to base station ID 730 (e.g., ‘482253’). Diagram 700 also depicts that a certain 8-bit CID (e.g., an ID equal to ‘00010101’) may translate to CID 740 (e.g., ‘21’). Additionally, diagram 750 shows database 760 including a number of corresponding values. Database 760 includes a mobile country code (MCC) (e.g., MCC 761), a mobile network code (MNC) (e.g., MNC 762), a cell identity (e.g., CI 763), a base station ID (e.g., base station ID 764), a CID (e.g., CID 765), a physical cell ID (PCI) (e.g., PCI 766), and a frequency (e.g., frequency 767).

As shown in FIG. 7, diagram 700 and diagram 750 depict how CID 740 may be extracted from CI 763 in database 760. For instance, for a cell in a database, a 20-bit base station ID and 8-bit cell ID may be extracted from a cell identity value (e.g., cell identity 710). For example, for a certain cell global identifier (e.g., an E-UTRAN cell global identifier (ECGI)), (e.g., MCC=123, MNC=456, CI=123456789), aspects presented herein may determine the global base station ID (e.g., MCC 761=123, MNC 762=456, BS ID 764=482253). Aspects presented herein may repeat this process to determine the base station IDs (e.g., eNB IDs) for all cells (e.g., LTE cells) in the database (e.g., database 760). After this, aspects presented herein may search for all cells with the specific global base station ID (e.g., MCC=123, MNC=456, BS ID=482253). By doing so, aspects presented herein may identify a location of each of a set of cells based on a cell ID for each cell. Also, aspects presented herein may estimate an average location of the cells based on the location of each cell, and then calculate a location of a base station or network node based on the average location of the cells. Aspects presented herein may then transmit an indication of the calculated location of the base station or network node.

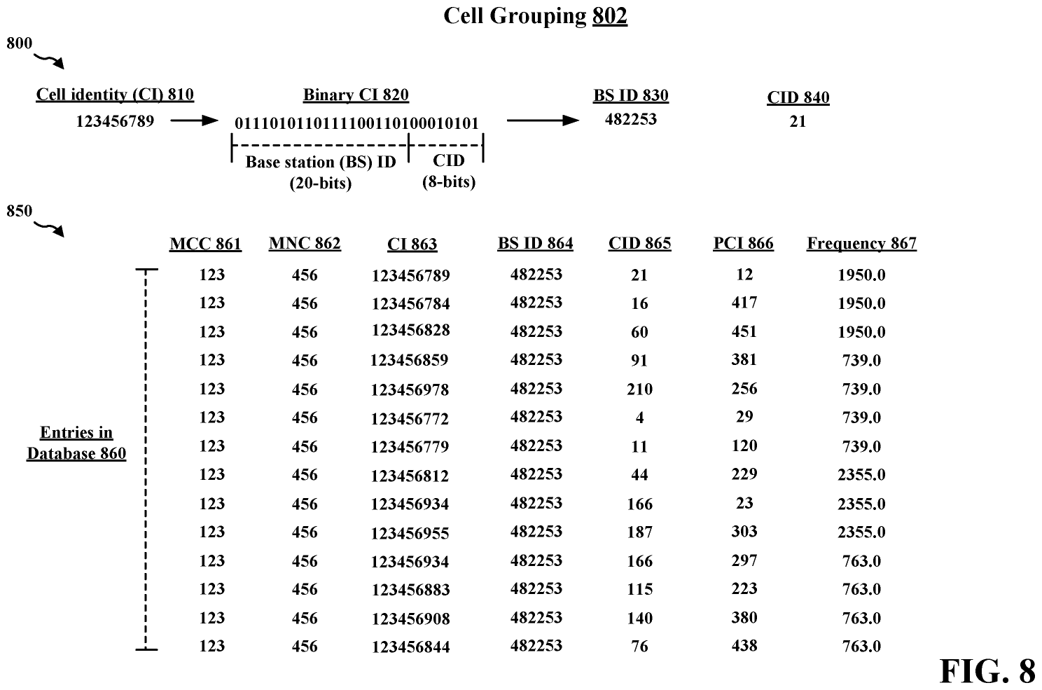

FIG. 8 is a diagram 800 and diagram 850 illustrating an example cell grouping (e.g., cell grouping 802) for a wireless communication system. More specifically, FIG. 8 depicts how a cell ID (CID) can be extracted from a cell identity (CI) in a database, including location identification of a set of cells with multiple database listings for multiple cells. As shown in FIG. 8, diagram 800 includes cell identity 810, binary CI 820, base station ID 830, and CID 840. For instance, cell identity 810 is a 9-digit number (e.g., ‘123456789’), binary CI 820 is a 28-bit number including 20-bits for the base station ID (e.g., base station ID 830) and 8-bits for the CID (e.g., CID 840). Also, diagram 800 depicts that a certain 20-bit base station ID (e.g., an ID equal to ‘01110101101111001101’) may translate to base station ID 830 (e.g., ‘482253’). Diagram 800 also depicts that a certain 8-bit CID (e.g., an ID equal to ‘00010101’) may translate to CID 840 (e.g., ‘21’). Additionally, diagram 850 shows database 860 including a number of corresponding entries (e.g., 14 entries). Database 860 includes a mobile country code (MCC) (e.g., MCC 861), a mobile network code (MNC) (e.g., MNC 862), a cell identity (e.g., CI 863), a base station ID (e.g., base station ID 864), a CID (e.g., CID 865), a physical cell ID (PCI) (e.g., PCI 866), and a frequency (e.g., frequency 867) for each of the entries (e.g., 14 entries) in database 860 that correspond to different cells (e.g., 14 cells).

As shown in FIG. 8, diagram 800 and diagram 850 depict how CID 840 may be extracted from CI 863 in database 860. For instance, for a cell in a database, a 20-bit base station ID and 8-bit cell ID can be extracted from a cell identity value (e.g., cell identity 810). For example, for a certain cell global identifier (e.g., an E-UTRAN cell global identifier (ECGI)), (e.g., MCC=123, MNC=456, CI=123456789), aspects presented herein may determine the global base station ID (e.g., MCC 861=123, MNC 862=456, BS ID 864=482253). Aspects presented herein may repeat this process to determine the base station IDs (e.g., eNB IDs) for all cells (e.g., LTE cells) in the database (e.g., database 860). After this, aspects presented herein may search for all cells with the specific global base station ID (e.g., MCC=123, MNC=456, BS ID=482253). By doing so, aspects presented herein may identify a location of each of a set of cells based on a cell ID for each cell. Also, aspects presented herein may estimate an average location of the cells based on the location of each cell, and then calculate a location of a base station or network node based on the average location of the cells. Aspects presented herein may then transmit an indication of the calculated location of the base station or network node. FIG. 8 shows that the CID (e.g., CID 865) may vary for each entry in the database 860 that corresponds to a different cell (e.g., one of 14 cells). For example, the CID 865 may be a number of different values (e.g., 21, 16, 60, 91, 210, 4, 11, 44, 166, 187, 166, 115, 140, and 76). Also, the PCI (e.g., PCI 866) may vary for each entry in the database 860 that corresponds to a different cell (e.g., one of 14 cells). For example, PCI 866 may be a number of different values (e.g., 12, 417, 451, 381, 256, 29, 120, 229, 23, 303, 297, 223, 380, and 438). Further, the frequency (e.g., frequency 867) may vary for each entry in the database 860 that corresponds to a different cell (e.g., one of 14 cells). For example, frequency 867 may be a number of different values (e.g., 1950.0, 739.0, 2355.0, and 763.0).

As depicted in FIG. 8, aspects presented herein may perform the aforementioned location identification of a set of cells with multiple database listings for multiple cells. For instance, based on a cell ID, aspects presented herein may perform a location identification of a set of cells with multiple database listings for multiple cells. For example, for a certain base station ID (e.g., a base station ID of ‘482253’), there may be a certain amount of cells (e.g., 14 cells) that are grouped with (or belong to) this particular base station (e.g., eNB or gNB). Additionally, there may be a certain amount of channels (e.g., 4 channels) that are associated with the database. For example, there may be multiple mid-band channels (e.g., two mid-band channels) with a certain number of cells per-channel (e.g., three cells per-channel) and multiple low-band channels (e.g., two low-band channels) with a certain number of cells per-channel (e.g., four cells per-channel). As depicted in FIG. 8, these cells (e.g., 14 cells) may be utilized to identify the location identification of each of the set of cells based on the cell ID in the database.

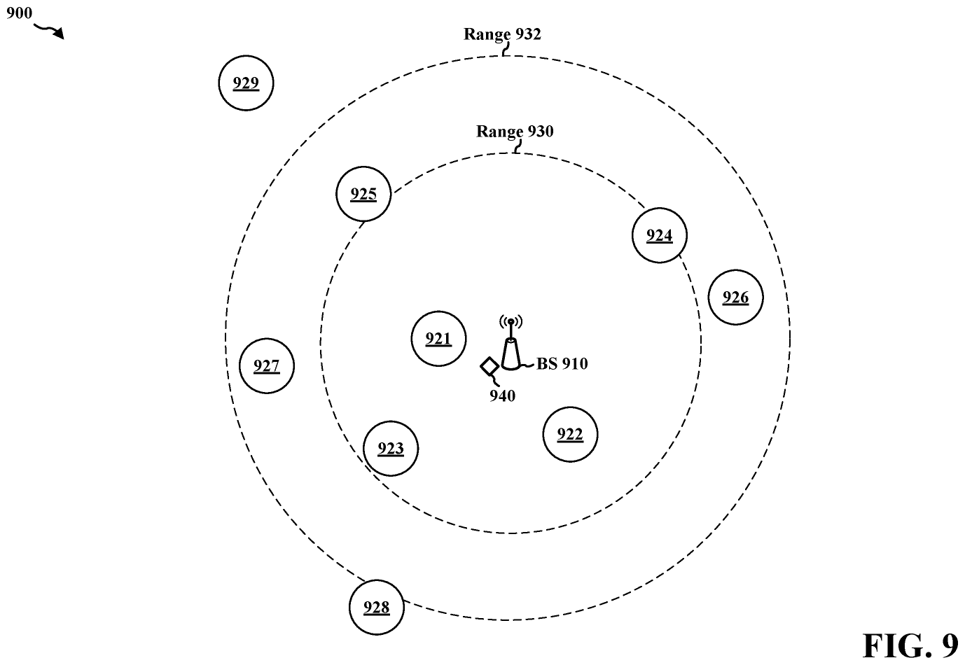

FIG. 9 is a diagram 900 illustrating example ranges for a base station and corresponding sector centers of cells in a wireless communication system. More specifically, FIG. 9 depicts a base station and corresponding sector centers of cells including several ranges. As shown in FIG. 9, diagram 900 includes base station 910 and corresponding sector centers of cells (e.g., sector center 921, sector center 922, sector center 923, sector center 924, sector center 925, sector center 926, sector center 927, sector center 928, and sector center 929), range 930, range 932, and weighted mean sector center 940. Range 930 may be a certain distance around base station 910 (e.g., 500 feet), and range 932 may be a larger distance around base station 910 (e.g., 1000 feet). As shown in FIG. 9, sector center 921, sector center 922, and sector center 923 may be within range 930. Sector center 924, sector center 925, sector center 926, and sector center 927 may be within range 932. Also, sector center 928 and sector center 929 may be outside of range 932. Further, weighted mean sector center 940 may be a weighted mean (i.e., weighted average) of the sector center location of sector centers 921-929. A sector center may be a center of a sector, an area, or a coverage area within a network for a cell. It is noted that the sector centers that lie on the boundary of a certain range may be considered either within that range or outside of that range.

As shown in FIG. 9, servers or network entities (not shown) may utilize the location of each of sector centers 921-929 in order to locate the base station 910. For example, a server or network entity may detect sector centers 921-929, where each of the sector centers 921-929 may be associated with a cell ID of the corresponding cell. Based on the cell ID for each of the sector centers 921-929, a server or network entity may identify a location of each of the sector centers 921-929. Also, the server or network entity may estimate an average location of the sector centers 921-929 based on the location of the cells. This average location of the sector centers 921-929 may be a weighted mean (i.e., weighted average) of the location of sector centers 921-929, which may correspond to weighted mean sector center 940. In some aspects, the average location of the sector centers 921-929 may be an unweighted mean (i.e., unweighted average) of the location of sector centers 921-929. Based on the average location of the sector centers 921-929, the server or network entity may calculate a location of the base station 910. The server or network entity may then transmit an indication of the calculated location of the base station 910. Additionally, a server of network entity may crowdsource data for each of the sector centers 921-929, such as crowdsource data associated with the coverage area for each of the sector centers 921-929. A coverage area may be an area that includes a network coverage for a cell or node in the network. Based on the crowdsourced data, the server or network entity may determine a location of the coverage area for each of sector centers 921-929. As shown in FIG. 9, the coverage areas may be sector centers, where the location of each of the sector centers 921-929 may be identified based on at least one sector center (e.g., weighted mean sector center 940) in the sector centers. Further, a server or network entity may calculate a location of at least one cell based on the average location of the sector centers 921-929, where the at least one cell may be at least one unknown cell associated with the sector centers 921-929. Moreover, each of the sector centers 921-929 may be associated with at least one of a mobile country code (MCC), a mobile network code (MNC), a CI, a base station ID, a physical cell ID (PCI), or a frequency (e.g., MCC 761 or MCC 861, MNC 762 or MNC 862, CI 763 or CI 863, base station ID 764 or base station ID 864, PCI 766 or PCI 866, and/or frequency 767 or frequency 867).

In some instances, cells (e.g., LTE cells) that are unknown to a database (i.e., not in a database) may be associated with base stations (e.g., eNBs). That is, a cell lookup function may fail for a certain database. For instance, a database lookup for the certain cells (e.g., NB-IoT cells) may fail since there is no cell matching cell global identifier (e.g., ECGI) in the database. These types of cells (i.e., a cell without a matching cell global identifier) may be referred to as unknown cells. However, the cell (e.g., NB-IoT cell) may belong to a base station (e.g., eNB) with a certain number of cells (e.g., 14 LTE cells) in the database. Aspects presented herein may assume that the cell (e.g., NB-IoT cell) has been deployed at this particular base station.

Aspects presented herein may also determine a base station position and corresponding uncertainty that is derived from cells (e.g., LTE cells). For instance, aspects presented herein may utilize a test scan site for certain base stations. In some instances, the serving cell (e.g., NB-IoT serving cell) may not be in the database. The base station may be associated with a position and an uncertainty range. Further, this base station position and uncertainty range may be consistent with the test site. Based on the base station position and uncertainty range, the database may return a base station position and uncertainty for many unknown cells (e.g., LTE cells, CAT-M1 cells, and NB-IoT cells). As indicated herein, an unknown cell may be a cell that does not include an identifier (ID) that is known to the database. For example, an unknown cell may be a cell that is not found in a database based on its cell ID (e.g., because it has not been crowdsourced). That is, in some instances, an unknown cell may be a cell that does not otherwise exist in a database.

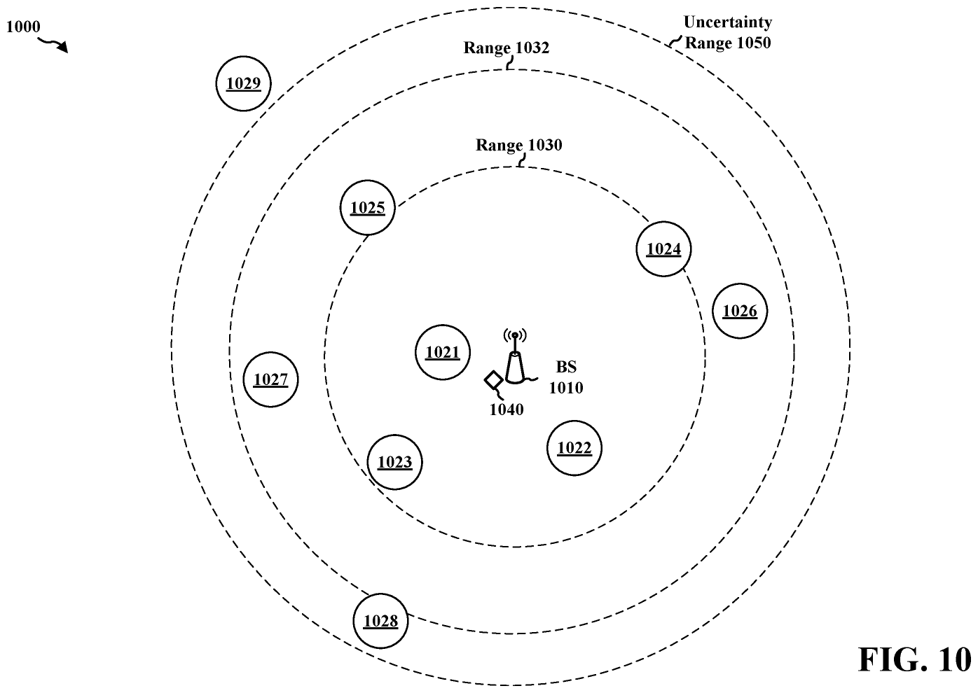

FIG. 10 is a diagram 1000 illustrating example ranges for a base station and corresponding sector centers of cells in a wireless communication system. More specifically, FIG. 10 depicts a base station and corresponding sector centers of cells including several ranges and an uncertainty range. As shown in FIG. 10, diagram 1000 includes base station 1010 and corresponding sector centers of cells (e.g., sector center 1021, sector center 1022, sector center 1023, sector center 1024, sector center 1025, sector center 1026, sector center 1027, sector center 1028, and sector center 1029), range 1030, range 1032, weighted mean sector center 1040, and uncertainty range 1050. Range 1030 may be a certain distance around base station 1010 (e.g., 500 feet), and range 1032 may be a larger distance around base station 1010 (e.g., 1000 feet). Uncertainty range 1050 may be an even larger distance around base station 1010 (e.g., 1500 feet). As shown in FIG. 10, sector center 1021, sector center 1022, and sector center 1023 may be within range 1030. Sector center 1024, sector center 1025, sector center 1026, and sector center 1027 may be within range 1032. Also, sector center 1028 may be within uncertainty range 1050, while sector center 1029 may be outside of uncertainty range 1050. Further, weighted mean sector center 1040 may be a weighted mean (i.e., average) of the location of sector centers 1021-1029. It is noted that the sector centers that lie on the boundary of a certain range may be considered either within that range or outside of that range.

As shown in FIG. 10, servers or network entities (not shown) may utilize the location of each of sector centers 1021-1029 in order to locate the base station 1010. For example, a server or network entity may detect sector centers 1021-1029, where each of the sector centers 1021-1029 may be associated with a cell ID. Based on the cell ID for each of the sector centers 1021-1029, a server or network entity may identify a location of each of the sector centers 1021-1029. Also, the server or network entity may estimate an average location of the sector centers 1021-1029 based on the location of the cells. As depicted in FIG. 10, the location of the base station 1010 may be associated with an uncertainty value (e.g., uncertainty range 1050) corresponding to the average location of the sector centers 1021-1029. In the uncertainty range 1050, a server or database may return a position of base station 1010 and an uncertainty for the unknown cells corresponding to sector centers 1021-1029. In some instances, the average location of the sector centers 1021-1029 may be a weighted mean (i.e., average) of the location of sector centers 1021-1029, which may correspond to weighted mean sector center 1040. The average location of the cells or sector centers may be based on a weighted average of the location of each of the cells or sector centers or an unweighted average of the location of each of the cells or sector centers. A weighted average may assign weights that determine in advance the relative importance of each data point. In some instances, weights may be computed based on an uncertainty (or size) of the sector center positions in individual coverage areas. A weighted average may be computed to equalize the frequency of the values in a data set. An unweighted average may be a method of taking a mean where all numbers are treated equally and assigned an equal weight. Based on the average location of the cells corresponding to sector centers 1021-1029, the server or network entity may calculate a location of the base station 1010. The server or network may also transmit an indication of the calculated location of the base station 1010. Additionally, a server of network entity may crowdsource data for each of the cells corresponding to sector centers 1021-1029, such as crowdsource data associated with the coverage area for each of the cells corresponding to sector centers 1021-1029. Based on the crowdsourced data, the server or network entity may determine a location of the coverage area for each of cells corresponding to sector centers 1021-1029. As shown in FIG. 10, the coverage areas may be sector centers, where the location of each of the cells corresponding to the sector centers 1021-1029 may be identified based on at least one sector center (e.g., weighted mean sector center 1040) in the sector centers. Further, a server or network entity may calculate a location of at least one cell based on the average location of the sector centers 1021-1029, where the at least one cell may be at least one unknown cell associated with the sector centers 1021-1029. Moreover, each of the cells corresponding to sector centers 1021-1029 may be associated with at least one of a mobile country code (MCC), a mobile network code (MNC), a CI, a base station ID, a physical cell ID (PCI), or a frequency (e.g., MCC 761 or MCC 861, MNC 762 or MNC 862, CI 763 or CI 863, base station ID 764 or base station ID 864, PCI 766 or PCI 866, and/or frequency 767 or frequency 867).

In some aspects, a server or network entity may utilize antenna positions of the cells in order to determine a location of a base station. For instance, some base stations (e.g., eNBs) may include a large standard deviation associated with cell antennas. If the cells do not group together well (i.e., the cells do not group together in an orderly fashion), the bit length in the database may need to be adjusted. For example, the bit length of a base station ID may need to be adjusted if cells do not group together well (i.e., the cells do not group together in an orderly fashion). In some aspects, the quality of a base station position may be assessed. For instance, the standard deviation (i.e., spread) of base station cells may be too large to represent a single base station site. This may occur because the cell antennas are not physically at the same location, or because the bit-length chosen for the base station ID is not accurate. In this case, different bit-lengths of the base station ID may be tested to determine if the cells will group better with a different bit-length base station ID. Additionally, to assess the quality of a base station position, the base station locations that are derived may be compared to a separate database that includes cell antenna locations.

Some types of networks (e.g., LTE networks, such as NB-IoT) may not have enough observations to maintain a crowdsourced database. However, certain types of air interfaces (e.g., an NB-IoT air interface) may be deployed on existing networks (e.g., LTE networks). In one embodiment, positioning for observed NB-IoT cells may be performed when a crowdsourced LTE database already exists. The existing crowdsourced LTE database may be used to form a position estimate for each base station (e.g., gNB or eNB) by locating all of the cells belonging to each gNB or eNB grouped at base station sites. Additionally, certain types of cells (e.g., new NB-IoT cells) which are not be found in the database with their cell identifier (e.g., because they have not been crowdsourced) may be associated with gNBs/eNBs and the computed gNB/eNB position may be used for a terrestrial position estimate for the user of the cell (e.g., an NB-IoT cell).

Aspects of the present disclosure may include a number of benefits or advantages. For instance, aspects presented herein may allow for new cells that cannot be found in a database based on their cell ID (because they have not been crowdsourced) to be associated with base stations, and the computed base station position may be used for a terrestrial position estimate of the cell. Furthermore, the results of this association at the server or network entity may be saved and seeded back into the database as a form of coarse crowdsourcing. As a result, this may help to build a new database. This database can then be updated/replaced by true GNSS-aided crowdsourcing later as the device population increases. The seeded database may be used for both single-cell and multi-cell terrestrial positioning. As such, aspects presented herein may provide positioning and crowdsourcing for cells that do not otherwise exist in a database.

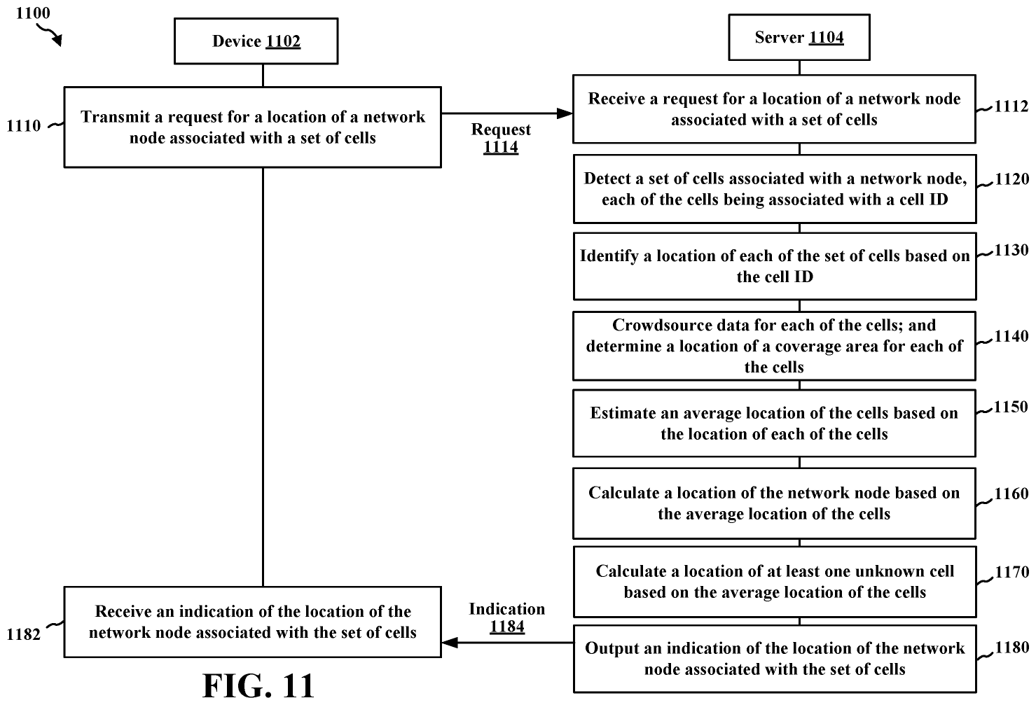

FIG. 11 is a communication flow diagram 1100 of wireless communication in accordance with one or more techniques of this disclosure. As shown in FIG. 11, diagram 1100 includes example communications between device 1102 (e.g., a wireless device or UE) and server 1104 (e.g., a network or network entity), in accordance with one or more techniques of this disclosure. In some aspects, device 1102 may be a first wireless device (e.g., UE, base station, TRP, or network entity) and server 1104 may be a second wireless device (e.g., UE, base station, TRP, network entity, or server).

At 1110, device 1102 may transmit, to a network entity, a request (e.g., request 1114) for a location of a network node associated with a set of cells, where each of the set of cells includes a cell identifier (ID), where the cell ID for each of the set of cells is associated with a node ID for the network node.

At 1112, server 1104 may receive, from at least one device, a request (e.g., request 1114) for a location of a network node prior to a detection of a set of cells associated with the network node. The server 1104 may also transmit, for the at least one device based on the request, an indication (e.g., indication 1184) of a location of the network node after a calculation of a location of the network node.

At 1120, server 1104 may detect a set of cells associated with a network node, where each of the set of cells includes a cell identifier (ID), where the cell ID for each of the set of cells is associated with a node ID for the network node. Also, each of the set of cells may be further associated with at least one of a mobile country code (MCC), a mobile network code (MNC), a physical cell ID (PCI), or a frequency. The cell ID for each of the set of cells may be stored in a database or a memory, where the location of each of the set of cells may be identified based on the cell ID stored in the database or the memory.

At 1130, server 1104 may identify a location of each of the set of cells based on the cell ID for each of the set of cells. The network entity may be a server, a location server, a positioning server, a cloud server, an edge server, a network, or a location management function (LMF), the network node may be a base station or a transmission-reception point (TRP), and each of the set of cells may be within a coverage area of the base station or the TRP.

In some aspects, each of the set of cells may be associated with a coverage area in a plurality of coverage areas, and where the location of each of the set of cells may be identified based on the coverage area associated with each of the set of cells. The plurality of coverage areas may be a plurality of sector centers, where the location of each of the set of cells may be identified based on at least one sector center in the plurality of sector centers.

At 1140, server 1104 may crowdsource data for each of the set of cells associated with each of the plurality of coverage areas; and determine a location of the coverage area for each of the set of cells based on the crowdsourced data, where the location of each of the set of cells is identified based on the location of the coverage area.

At 1150, server 1104 may estimate an average location of the set of cells based on the location of each of the set of cells. In some aspects, estimating the average location of the set of cells may include: averaging the location of each of the set of cells to obtain the average location of the set of cells. That is, the server may average the location of each of the set of cells to obtain the average location of the set of cells. Also, the average location of the set of cells may be based on a weighted average of the location of each of the set of cells or an unweighted average of the location of each of the set of cells. The weighted average or the unweighted average may be based on a coverage area of each of the set of cells.

At 1160, server 1104 may calculate a location of the network node based on the average location of the set of cells. The location of the network node may be associated with an uncertainty value corresponding to the average location of the set of cells.

At 1170, server 1104 may calculate a location of at least one cell based on the average location of the set of cells, where the at least one cell is at least one unknown cell associated with the set of cells. The at least one unknown cell may be associated with the set of cells based on the node ID for the network node. The location of the at least one unknown cell and the location of the network node may be stored in a database or a memory.

At 1180, server 1104 may output an indication of the location of the network node (e.g., indication 1184) after the calculation of the location of the network node. In some aspects, outputting the indication may comprise (i.e., include) transmitting, for at least one device, the indication of the location of the network node. That is, the server may transmit, for at least one device, the indication of the location of the network node. Also, outputting the indication may comprise storing, in a first memory or a cache, the indication of the location of the network node. That is, the server may store the indication of the location of the network node.

At 1182, device 1102 may receive, from the network entity based on the request, an indication of the location of the network node associated with the set of cells (e.g., indication 1184), where the location of the network node is based on an average location of the set of cells.

In some aspects, the network entity may be a server, a location server, a positioning server, a cloud server, an edge server, a network, or a location management function (LMF), the network node may be a base station or a transmission-reception point (TRP), and each of the set of cells may be within a coverage area of the base station or the TRP. Also, each of the set of cells may be further associated with at least one of a mobile country code (MCC), a mobile network code (MNC), a physical cell ID (PCI), or a frequency. The cell ID for each of the set of cells may be stored in a database or a memory, where the location of each of the set of cells may be identified based on the cell ID stored in the database or the memory.

In some instances, each of the set of cells may be associated with a coverage area in a plurality of coverage areas, and where the location of each of the set of cells may be identified based on the coverage area associated with each of the set of cells. The plurality of coverage areas may be a plurality of sector centers, where the location of each of the set of cells may be identified based on at least one sector center in the plurality of sector centers. Also, the average location of the set of cells may be based on a weighted average of the location of each of the set of cells or an unweighted average of the location of each of the set of cells. The weighted average or the unweighted average may be based on a coverage area of each of the set of cells. The location of at least one cell may be based on the average location of the set of cells, where the at least one cell is at least one unknown cell associated with the set of cells. The at least one unknown cell may be associated with the set of cells based on the node ID for the network node. The location of the at least one unknown cell and the location of the network node may be stored in a database or a memory. Also, the location of the network node may be associated with an uncertainty value corresponding to the average location of the set of cells.

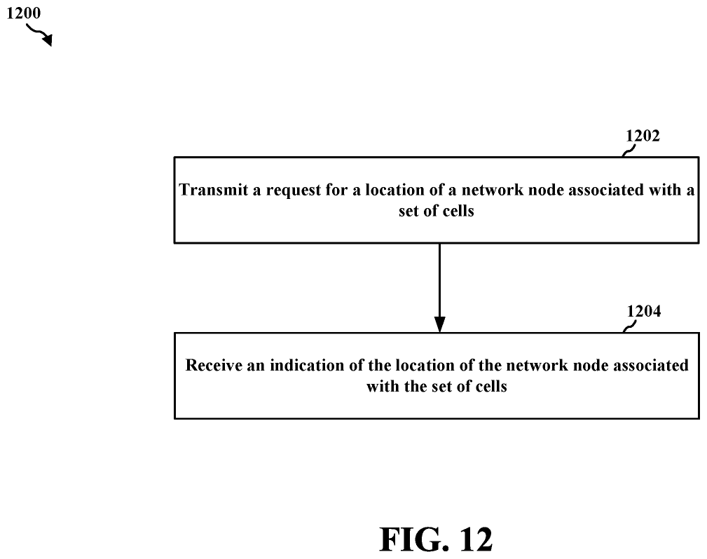

FIG. 12 is a flowchart 1200 of a method of wireless communication. The method may be performed by a device or a UE (e.g., the UE 104, device 1102; the apparatus 1604). The methods described herein may provide a number of benefits, such as improving resource utilization and/or power savings.

At 1202, the device may transmit, to a network entity, a request for a location of a network node associated with a set of cells, where each of the set of cells includes a cell identifier (ID), where the cell ID for each of the set of cells is associated with a node ID for the network node, as discussed with respect to FIGS. 4-11. For example, as described in 1110 of FIG. 11, the device 1102 may transmit, to a network entity, a request for a location of a network node associated with a set of cells, where each of the set of cells includes a cell identifier (ID), where the cell ID for each of the set of cells is associated with a node ID for the network node. Further, step 1202 may be performed by location component 198.

At 1204, the device may receive, from the network entity based on the request, an indication of the location of the network node associated with the set of cells, where the location of the network node is based on an average location of the set of cells, as discussed with respect to FIGS. 4-11. For example, as described in 1182 of FIG. 11, the device 1102 may receive, from the network entity based on the request, an indication of the location of the network node associated with the set of cells, where the location of the network node is based on an average location of the set of cells. Further, step 1204 may be performed by location component 198.

In some aspects, the network entity may be a server, a location server, a positioning server, a cloud server, an edge server, a network, or a location management function (LMF), the network node may be a base station or a transmission-reception point (TRP), and each of the set of cells may be within a coverage area of the base station or the TRP. Also, each of the set of cells may be further associated with at least one of a mobile country code (MCC), a mobile network code (MNC), a physical cell ID (PCI), or a frequency. The cell ID for each of the set of cells may be stored in a database or a memory, where the location of each of the set of cells may be identified based on the cell ID stored in the database or the memory.

In some instances, each of the set of cells may be associated with a coverage area in a plurality of coverage areas, and where the location of each of the set of cells may be identified based on the coverage area associated with each of the set of cells. The plurality of coverage areas may be a plurality of sector centers, where the location of each of the set of cells may be identified based on at least one sector center in the plurality of sector centers. Also, the average location of the set of cells may be based on a weighted average of the location of each of the set of cells or an unweighted average of the location of each of the set of cells. The weighted average or the unweighted average may be based on a coverage area of each of the set of cells. The location of at least one cell may be based on the average location of the set of cells, where the at least one cell is at least one unknown cell associated with the set of cells. The at least one unknown cell may be associated with the set of cells based on the node ID for the network node. The location of the at least one unknown cell and the location of the network node may be stored in a database or a memory. Also, the location of the network node may be associated with an uncertainty value corresponding to the average location of the set of cells.

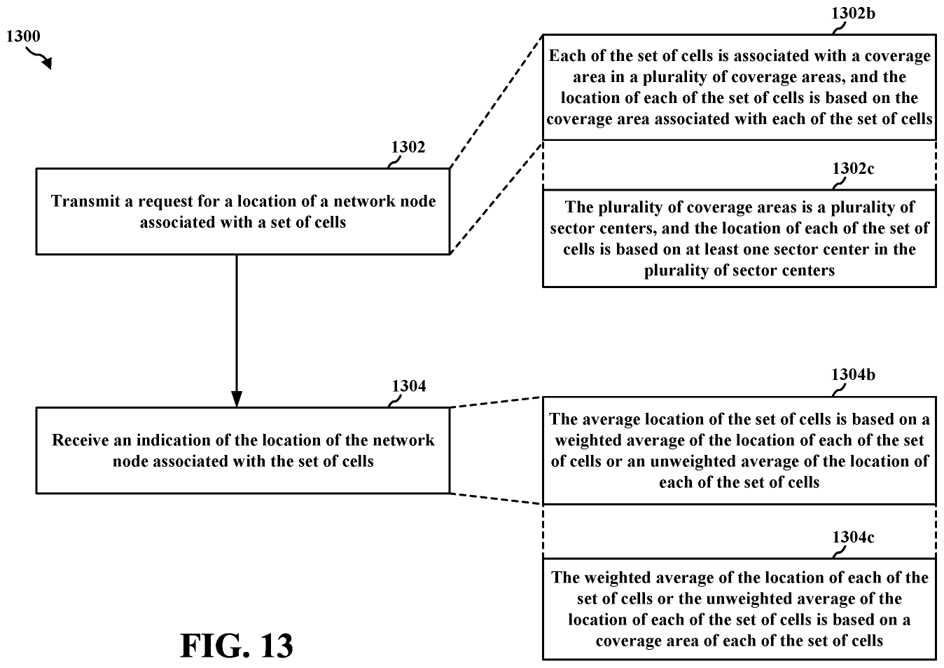

FIG. 13 is a flowchart 1300 of a method of wireless communication. The method may be performed by a device or a UE (e.g., the UE 104, device 1102; the apparatus 1604). The methods described herein may provide a number of benefits, such as improving resource utilization and/or power savings.

At 1302, the device may transmit, to a network entity, a request for a location of a network node associated with a set of cells, where each of the set of cells includes a cell identifier (ID), where the cell ID for each of the set of cells is associated with a node ID for the network node, as discussed with respect to FIGS. 4-11. For example, as described in 1110 of FIG. 11, the device 1102 may transmit, to a network entity, a request for a location of a network node associated with a set of cells, where each of the set of cells includes a cell identifier (ID), where the cell ID for each of the set of cells is associated with a node ID for the network node. Further, step 1302 may be performed by location component 198.

At 1304, the device may receive, from the network entity based on the request, an indication of the location of the network node associated with the set of cells, where the location of the network node is based on an average location of the set of cells, as discussed with respect to FIGS. 4-11. For example, as described in 1182 of FIG. 11, the device 1102 may receive, from the network entity based on the request, an indication of the location of the network node associated with the set of cells, where the location of the network node is based on an average location of the set of cells. Further, step 1304 may be performed by location component 198.

In some aspects, the network entity may be a server, a location server, a positioning server, a cloud server, an edge server, a network, or a location management function (LMF), the network node may be a base station or a transmission-reception point (TRP), and each of the set of cells may be within a coverage area of the base station or the TRP. Also, each of the set of cells may be further associated with at least one of a mobile country code (MCC), a mobile network code (MNC), a physical cell ID (PCI), or a frequency. The cell ID for each of the set of cells may be stored in a database or a memory, where the location of each of the set of cells may be identified based on the cell ID stored in the database or the memory.

As shown at 1302b, each of the set of cells may be associated with a coverage area in a plurality of coverage areas, and the location of each of the set of cells may be identified based on the coverage area associated with each of the set of cells. As shown at 1302c, the plurality of coverage areas may be a plurality of sector centers, and the location of each of the set of cells may be identified based on at least one sector center in the plurality of sector centers. As shown at 1304b, the average location of the set of cells may be based on a weighted average of the location of each of the set of cells or an unweighted average of the location of each of the set of cells. As shown at 1304c, the weighted average of the location of each of the set of cells or the unweighted average of the location of each of the set of cells may be based on a coverage area of each of the set of cells. The location of at least one cell may be based on the average location of the set of cells, where the at least one cell is at least one unknown cell associated with the set of cells. The at least one unknown cell may be associated with the set of cells based on the node ID for the network node. The location of the at least one unknown cell and the location of the network node may be stored in a database or a memory. Also, the location of the network node may be associated with an uncertainty value corresponding to the average location of the set of cells.

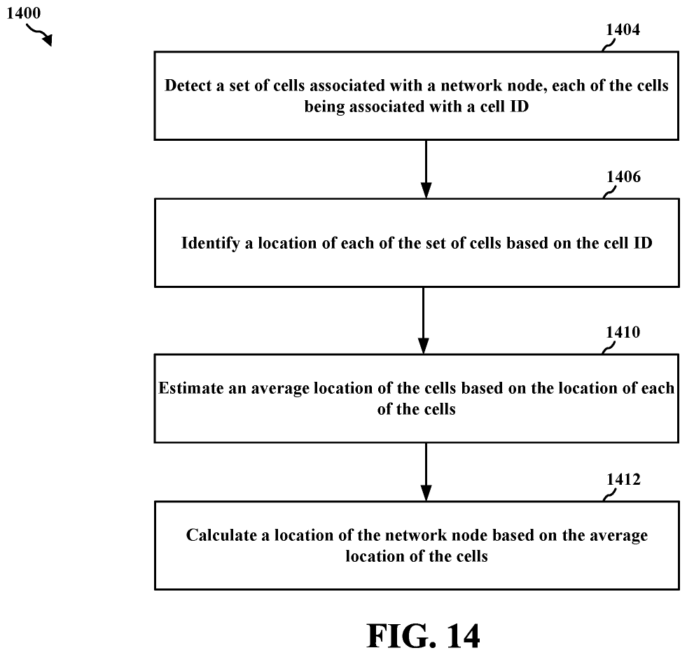

FIG. 14 is a flowchart 1400 of a method of wireless communication. The method may be performed by a server or a network entity (e.g., LMF 166; server 1104; network entity 1860) or a base station (e.g., the base station 102; the network entity 1702). The methods described herein may provide a number of benefits, such as improving resource utilization and/or power savings.

At 1404, the server may detect a set of cells associated with a network node, where each of the set of cells includes a cell identifier (ID), where the cell ID for each of the set of cells is associated with a node ID for the network node, as discussed with respect to FIGS. 4-11. For example, as described in 1120 of FIG. 11, the server 1104 may detect a set of cells associated with a network node, where each of the set of cells includes a cell identifier (ID), where the cell ID for each of the set of cells is associated with a node ID for the network node. Further, step 1404 may be performed by location component 199. Also, each of the set of cells may be further associated with at least one of a mobile country code (MCC), a mobile network code (MNC), a physical cell ID (PCI), or a frequency. The cell ID for each of the set of cells may be stored in a database or a memory, where the location of each of the set of cells may be identified based on the cell ID stored in the database or the memory.

At 1406, the server may identify a location of each of the set of cells based on the cell ID for each of the set of cells, as discussed with respect to FIGS. 4-11. For example, as described in 1130 of FIG. 11, the server 1104 may identify a location of each of the set of cells based on the cell ID for each of the set of cells. Further, step 1406 may be performed by location component 199. The network entity may be a server, a location server, a positioning server, a cloud server, an edge server, a network, or a location management function (LMF), the network node may be a base station or a transmission-reception point (TRP), and each of the set of cells may be within a coverage area of the base station or the TRP.

In some aspects, each of the set of cells may be associated with a coverage area in a plurality of coverage areas, and where the location of each of the set of cells may be identified based on the coverage area associated with each of the set of cells. The plurality of coverage areas may be a plurality of sector centers, where the location of each of the set of cells may be identified based on at least one sector center in the plurality of sector centers.

At 1410, the server may estimate an average location of the set of cells based on the location of each of the set of cells, as discussed with respect to FIGS. 4-11. For example, as described in 1150 of FIG. 11, the server 1104 may estimate an average location of the set of cells based on the location of each of the set of cells. Further, step 1410 may be performed by location component 199. In some aspects, estimating the average location of the set of cells may include: averaging the location of each of the set of cells to obtain the average location of the set of cells. That is, the server may average the location of each of the set of cells to obtain the average location of the set of cells. Also, the average location of the set of cells may be based on a weighted average of the location of each of the set of cells or an unweighted average of the location of each of the set of cells. The weighted average or the unweighted average may be based on a coverage area of each of the set of cells.

At 1412, the server may calculate a location of the network node based on the average location of the set of cells, as discussed with respect to FIGS. 4-11. For example, as described in 1160 of FIG. 11, the server 1104 may calculate a location of the network node based on the average location of the set of cells. Further, step 1412 may be performed by location component 199. The location of the network node may be associated with an uncertainty value corresponding to the average location of the set of cells.

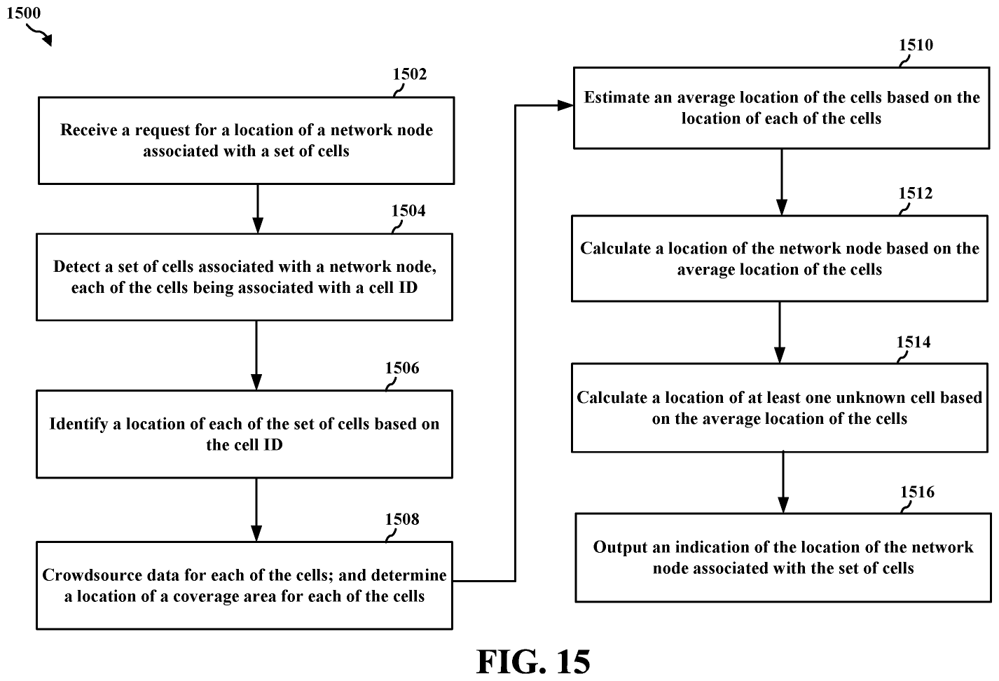

FIG. 15 is a flowchart 1500 of a method of wireless communication. The method may be performed by a server or a network entity (e.g., LMF 166; server 1104; network entity 1860) or a base station (e.g., the base station 102; the network entity 1702). The methods described herein may provide a number of benefits, such as improving resource utilization and/or power savings.

At 1502, the server may receive, from at least one device, a request for a location of a network node prior to a detection of a set of cells associated with the network node, as discussed with respect to FIGS. 4-11. For example, as described in 1112 of FIG. 11, the server 1104 may receive, from at least one device, a request for a location of a network node prior to a detection of a set of cells associated with the network node. Further, step 1502 may be performed by location component 199. The server may also transmit, for the at least one device based on the request, an indication (e.g., indication 1184) of a location of the network node after a calculation of a location of the network node.

At 1504, the server may detect a set of cells associated with a network node, where each of the set of cells includes a cell identifier (ID), where the cell ID for each of the set of cells is associated with a node ID for the network node, as discussed with respect to FIGS. 4-11. For example, as described in 1120 of FIG. 11, the server 1104 may detect a set of cells associated with a network node, where each of the set of cells includes a cell identifier (ID), where the cell ID for each of the set of cells is associated with a node ID for the network node. Further, step 1504 may be performed by location component 199. Also, each of the set of cells may be further associated with at least one of a mobile country code (MCC), a mobile network code (MNC), a physical cell ID (PCI), or a frequency. The cell ID for each of the set of cells may be stored in a database or a memory, where the location of each of the set of cells may be identified based on the cell ID stored in the database or the memory.

At 1506, the server may identify a location of each of the set of cells based on the cell ID for each of the set of cells, as discussed with respect to FIGS. 4-11. For example, as described in 1130 of FIG. 11, the server 1104 may identify a location of each of the set of cells based on the cell ID for each of the set of cells. Further, step 1506 may be performed by location component 199. The network entity may be a server, a location server, a positioning server, a cloud server, an edge server, a network, or a location management function (LMF), the network node may be a base station or a transmission-reception point (TRP), and each of the set of cells may be within a coverage area of the base station or the TRP.

In some aspects, each of the set of cells may be associated with a coverage area in a plurality of coverage areas, and where the location of each of the set of cells may be identified based on the coverage area associated with each of the set of cells. The plurality of coverage areas may be a plurality of sector centers, where the location of each of the set of cells may be identified based on at least one sector center in the plurality of sector centers.

At 1508, the server may crowdsource data for each of the set of cells associated with each of the plurality of coverage areas; and determine a location of the coverage area for each of the set of cells based on the crowdsourced data, where the location of each of the set of cells is identified based on the location of the coverage area, as discussed with respect to FIGS. 4-11. For example, as described in 1140 of FIG. 11, the server 1104 may crowdsource data for each of the set of cells associated with each of the plurality of coverage areas; and determine a location of the coverage area for each of the set of cells based on the crowdsourced data, where the location of each of the set of cells is identified based on the location of the coverage area. Further, step 1508 may be performed by location component 199.

At 1510, the server may estimate an average location of the set of cells based on the location of each of the set of cells, as discussed with respect to FIGS. 4-11. For example, as described in 1150 of FIG. 11, the server 1104 may estimate an average location of the set of cells based on the location of each of the set of cells. Further, step 1510 may be performed by location component 199. In some aspects, estimating the average location of the set of cells may include: averaging the location of each of the set of cells to obtain the average location of the set of cells. That is, the server may average the location of each of the set of cells to obtain the average location of the set of cells. Also, the average location of the set of cells may be based on a weighted average of the location of each of the set of cells or an unweighted average of the location of each of the set of cells. The weighted average or the unweighted average may be based on a coverage area of each of the set of cells.

At 1512, the server may calculate a location of the network node based on the average location of the set of cells, as discussed with respect to FIGS. 4-11. For example, as described in 1160 of FIG. 11, the server 1104 may calculate a location of the network node based on the average location of the set of cells. Further, step 1512 may be performed by location component 199. The location of the network node may be associated with an uncertainty value corresponding to the average location of the set of cells.

At 1514, the server may calculate a location of at least one cell based on the average location of the set of cells, where the at least one cell is at least one unknown cell associated with the set of cells, as discussed with respect to FIGS. 4-11. For example, as described in 1170 of FIG. 11, the server 1104 may calculate a location of at least one cell based on the average location of the set of cells, where the at least one cell is at least one unknown cell associated with the set of cells. Further, step 1514 may be performed by location component 199. The at least one unknown cell may be associated with the set of cells based on the node ID for the network node. The location of the at least one unknown cell and the location of the network node may be stored in a database or a memory.

At 1516, the server may output an indication of the location of the network node after the calculation of the location of the network node, as discussed with respect to FIGS. 4-11. For example, as described in 1180 of FIG. 11, the server 1104 may output an indication of the location of the network node (e.g., indication 1184) after the calculation of the location of the network node. Further, step 1516 may be performed by location component 199. In some aspects, outputting the indication may comprise transmitting, for at least one device, the indication of the location of the network node. That is, the server may transmit, for at least one device, the indication of the location of the network node. Also, outputting the indication may comprise storing, in a first memory or a cache, the indication of the location of the network node. That is, the server may store the indication of the location of the network node.

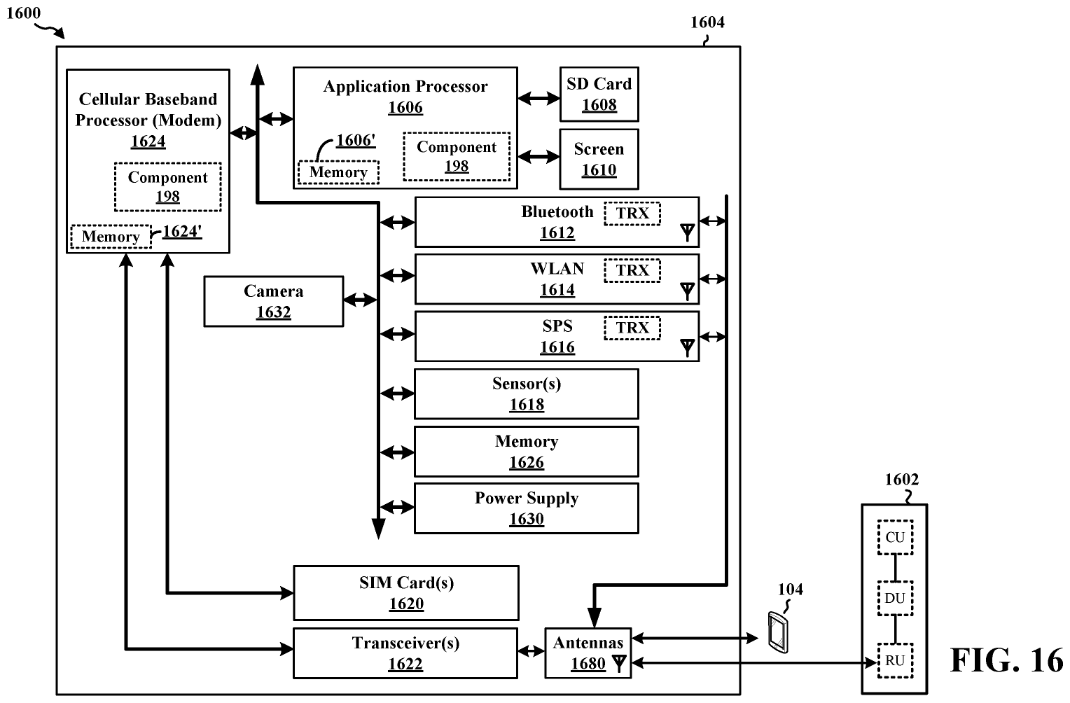

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see 350 of FIG. 3) and include the additional modules of the apparatus 1604.

As discussed supra, the location component 198 may be configured to transmit, to a network entity, a request for a location of a network node associated with a set of cells, where each of the set of cells includes a cell identifier (ID), where the cell ID for each of the set of cells is associated with a node ID for the network node. The location component 198 may also be configured to receive, from the network entity based on the request, an indication of the location of the network node associated with the set of cells, where the location of the network node is based on an average location of the set of cells.

The location component 198 may be within the cellular baseband processor 1624, the application processor 1606, or both the cellular baseband processor 1624 and the application processor 1606. The location component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for transmitting, to a network entity, a request for a location of a network node associated with a set of cells, where each of the set of cells includes a cell identifier (ID), where the cell ID for each of the set of cells is associated with a node ID for the network node. The apparatus 1604 may also include means for receiving, from the network entity based on the request, an indication of the location of the network node associated with the set of cells, where the location of the network node is based on an average location of the set of cells. The means may be the location component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

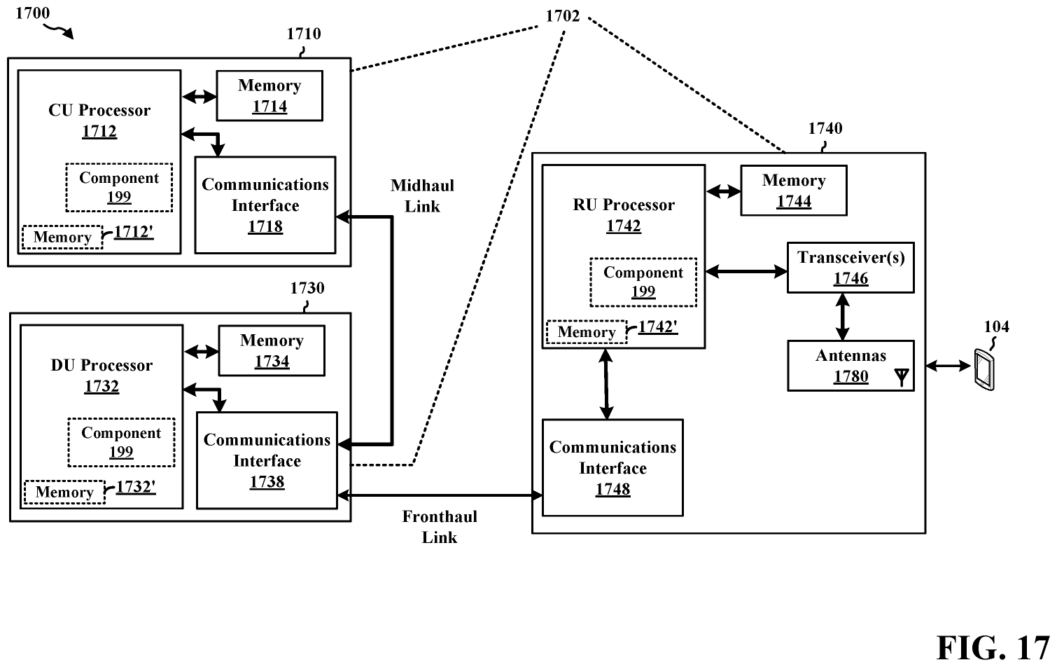

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the location component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the location component 199 may be configured to detect a set of cells associated with a network node, where each of the set of cells includes a cell identifier (ID), where the cell ID for each of the set of cells is associated with a node ID for the network node. The location component 199 may also be configured to identify a location of each of the set of cells based on the cell ID for each of the set of cells. The location component 199 may also be configured to estimate an average location of the set of cells based on the location of each of the set of cells. The location component 199 may also be configured to calculate a location of the network node based on the average location of the set of cells. The location component 199 may also be configured to crowdsource data for each of the set of cells associated with each of the plurality of coverage areas; and determine a location of the coverage area for each of the set of cells based on the crowdsourced data, where the location of each of the set of cells is identified based on the location of the coverage area. The location component 199 may also be configured to receive, from at least one device, a request for the location of the network node prior to a detection of the set of cells associated with the network node. The location component 199 may also be configured to transmit, for the at least one device based on the request, an indication of the location of the network node after a calculation of the location of the network node. The location component 199 may also be configured to calculate a location of at least one cell based on the average location of the set of cells, where the at least one cell is at least one unknown cell associated with the set of cells. The location component 199 may also be configured to output an indication of the location of the network node based on the calculation of the location of the network node.

The location component 199 may be within one or more processors of one or more of the CU 1710, DU 1730, and the RU 1740. The location component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 may include means for detecting a set of cells associated with a network node, where each of the set of cells includes a cell identifier (ID), where the cell ID for each of the set of cells is associated with a node ID for the network node. The network entity 1702 may also include means for identifying a location of each of the set of cells based on the cell ID for each of the set of cells. The network entity 1702 may also include means for estimating an average location of the set of cells based on the location of each of the set of cells. The network entity 1702 may also include means for calculating a location of the network node based on the average location of the set of cells. The network entity 1702 may also include means for crowdsourcing data for each of the set of cells associated with each of the plurality of coverage areas. The network entity 1702 may also include means for determining a location of the coverage area for each of the set of cells based on the crowdsourced data, where the location of each of the set of cells is identified based on the location of the coverage area. The network entity 1702 may also include means for receiving, from at least one device, a request for the location of the network node prior to a detection of the set of cells associated with the network node. The network entity 1702 may also include means for transmitting, for the at least one device based on the request, an indication of the location of the network node after a calculation of the location of the network node. The network entity 1702 may also include means for calculating a location of at least one cell based on the average location of the set of cells, where the at least one cell is at least one unknown cell associated with the set of cells. The network entity 1702 may also include means for outputting an indication of the location of the network node based on the calculation of the location of the network node. The means may be the location component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

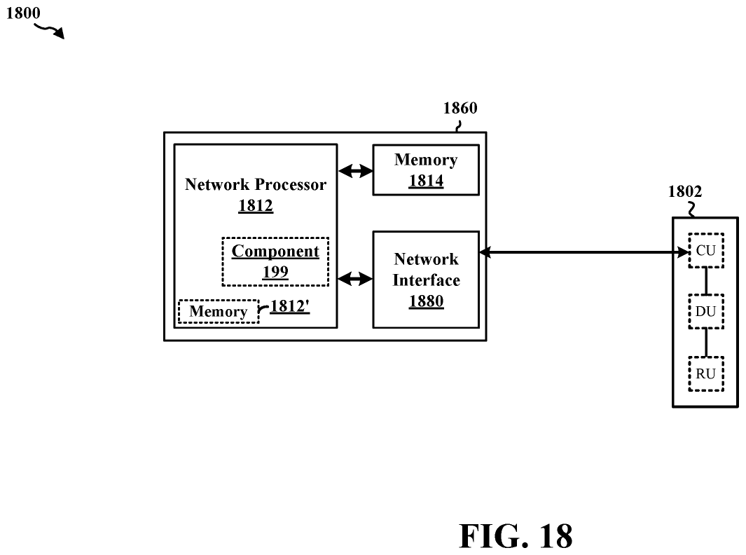

FIG. 18 is a diagram 1800 illustrating an example of a hardware implementation for a network entity 1860. In one example, the network entity 1860 may be within the core network 120. The network entity 1860 may include a network processor 1812. The network processor 1812 may include on-chip memory 1812′. In some aspects, the network entity 1860 may further include additional memory modules 1814. The network entity 1860 communicates via the network interface 1880 directly (e.g., backhaul link) or indirectly (e.g., through a RIC) with the CU 1802. The on-chip memory 1812′ and the additional memory modules 1814 may each be considered a computer-readable medium/memory. Each computer-readable medium/memory may be non-transitory. The processor 1812 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the location component 199 may be configured to detect a set of cells associated with a network node, where each of the set of cells includes a cell identifier (ID), where the cell ID for each of the set of cells is associated with a node ID for the network node. The location component 199 may also be configured to identify a location of each of the set of cells based on the cell ID for each of the set of cells. The location component 199 may also be configured to estimate an average location of the set of cells based on the location of each of the set of cells. The location component 199 may also be configured to calculate a location of the network node based on the average location of the set of cells. The location component 199 may also be configured to crowdsource data for each of the set of cells associated with each of the plurality of coverage areas; and determine a location of the coverage area for each of the set of cells based on the crowdsourced data, where the location of each of the set of cells is identified based on the location of the coverage area. The location component 199 may also be configured to receive, from at least one device, a request for the location of the network node prior to a detection of the set of cells associated with the network node. The location component 199 may also be configured to transmit, for the at least one device based on the request, an indication of the location of the network node after a calculation of the location of the network node. The location component 199 may also be configured to calculate a location of at least one cell based on the average location of the set of cells, where the at least one cell is at least one unknown cell associated with the set of cells. The location component 199 may also be configured to output an indication of the location of the network node based on the calculation of the location of the network node.

The location component 199 may be within the processor 1812. The location component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1860 may include a variety of components configured for various functions. In one configuration, the network entity 1860 may include means for detecting a set of cells associated with a network node, where each of the set of cells includes a cell identifier (ID), where the cell ID for each of the set of cells is associated with a node ID for the network node. The network entity 1860 may also include means for identifying a location of each of the set of cells based on the cell ID for each of the set of cells. The network entity 1860 may also include means for estimating an average location of the set of cells based on the location of each of the set of cells. The network entity 1860 may also include means for calculating a location of the network node based on the average location of the set of cells. The network entity 1860 may also include means for crowdsourcing data for each of the set of cells associated with each of the plurality of coverage areas. The network entity 1860 may also include means for determining a location of the coverage area for each of the set of cells based on the crowdsourced data, where the location of each of the set of cells is identified based on the location of the coverage area. The network entity 1860 may also include means for receiving, from at least one device a request for the location of the network node prior to a detection of the set of cells associated with the network node. The network entity 1860 may also include means for transmitting, for the at least one device based on the request, an indication of the location of the network node after a calculation of the location of the network node. The network entity 1860 may also include means for calculating a location of at least one cell based on the average location of the set of cells, where the at least one cell is at least one unknown cell associated with the set of cells. The network entity 1860 may also include means for outputting an indication of the location of the network node based on the calculation of the location of the network node. The means may be the location component 199 of the network entity 1860 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a network entity, including at least one memory and at least one processor coupled to the at least one memory and, based at least in part on information stored in the at least one memory, the at least one processor, individually or in any combination, is configured to: detect a set of cells associated with a network node, wherein each of the set of cells includes a cell identifier (ID), wherein the cell ID for each of the set of cells is associated with a node ID for the network node; identify a location of each of the set of cells based on the cell ID for each of the set of cells; estimate an average location of the set of cells based on the location of each of the set of cells; and calculate a location of the network node based on the average location of the set of cells.

Aspect 2 is the apparatus of aspect 1, wherein the at least one processor, individually or in any combination, is further configured to: output an indication of the location of the network node based on the calculation of the location of the network node.

Aspect 3 is the apparatus of aspect 2, wherein to output the indication of the location of the network node, the at least one processor, individually or in any combination, is configured to: transmit, for at least one device, the indication of the location of the network node; or store, in a first memory or a cache, the indication of the location of the network node.

Aspect 4 is the apparatus of any of aspects 1 to 3, wherein each of the set of cells is associated with a coverage area in a plurality of coverage areas, and wherein to identify the location of each of the set of cells, the at least one processor, individually or in combination, is configured to: identify the location of each of the set of cells based on the coverage area associated with each of the set of cells.

Aspect 5 is the apparatus of aspect 4, wherein the at least one processor, individually or in any combination, is further configured to: crowdsource data for each of the set of cells associated with each of the plurality of coverage areas; and determine a location of the coverage area for each of the set of cells based on the crowdsourced data, wherein to identify the location of each of the set of cells, the at least one processor, individually or in combination, is configured to: identify the location of each of the set of cells further based on the location of the coverage area.

Aspect 6 is the apparatus of any of aspects 4 to 5, wherein the plurality of coverage areas is a plurality of sector centers, wherein to identify the location of each of the set of cells, the at least one processor, individually or in combination, is configured to: identify the location of each of the set of cells further based on at least one sector center in the plurality of sector centers.

Aspect 7 is the apparatus of any of aspects 1 to 6, wherein to estimate the average location of the set of cells, the at least one processor, individually or in any combination, is configured to: average the location of each of the set of cells to obtain the average location of the set of cells.

Aspect 8 is the apparatus of any of aspects 1 to 7, wherein the average location of the set of cells is based on a weighted average of the location of each of the set of cells or an unweighted average of the location of each of the set of cells.

Aspect 9 is the apparatus of aspect 8, wherein the weighted average of the location of each of the set of cells or the unweighted average of the location of each of the set of cells is based on a coverage area of each of the set of cells.

Aspect 10 is the apparatus of any of aspects 1 to 9, wherein the at least one processor, individually or in any combination, is further configured to: receive, from at least one device, a request for the location of the network node prior to the detection of the set of cells associated with the network node; and transmit, for the at least one device based on the request, an indication of the location of the network node after the calculation of the location of the network node.

Aspect 11 is the apparatus of aspect 10, further comprising at least one of an antenna or a transceiver coupled to the at least one processor, wherein to transmit the indication of the location of the network node, the at least one processor, individually or in any combination, is configured to: transmit, via at least one of the antenna or a transceiver, the indication of the location of the network node.

Aspect 12 is the apparatus of any of aspects 1 to 11, wherein the at least one processor, individually or in any combination, is further configured to: calculate a location of at least one cell based on the average location of the set of cells, wherein the at least one cell is at least one unknown cell associated with the set of cells.

Aspect 13 is the apparatus of aspect 12, wherein the at least one unknown cell is associated with the set of cells based on the node ID for the network node, and wherein the location of the at least one unknown cell and the location of the network node is configured to be stored in a database or a first memory.

Aspect 14 is the apparatus of any of aspects 1 to 13, wherein the location of the network node is associated with an uncertainty value corresponding to the average location of the set of cells, and wherein each of the set of cells is further associated with at least one of a mobile country code (MCC), a mobile network code (MNC), a physical cell ID (PCI), or a frequency.

Aspect 15 is the apparatus of any of aspects 1 to 14, wherein the cell ID for each of the set of cells is configured to be stored in a database or a first memory, and wherein to identify the location of each of the set of cells, the at least one processor, individually or in combination, is configured to: identify the location of each of the set of cells based on the cell ID that is configured to be stored in the database or the first memory.

Aspect 16 is the apparatus of any of aspects 1 to 15, wherein the network entity is a server, a location server, a positioning server, a cloud server, an edge server, a network, or a location management function (LMF), wherein the network node is a base station or a transmission-reception point (TRP), and wherein each of the set of cells is within a coverage area of the base station or the TRP.

Aspect 17 is the apparatus of any of aspects 1 to 16, where the apparatus is a wireless communication device, further including at least one of an antenna or a transceiver coupled to the at least one processor.

Aspect 18 is a method of wireless communication for implementing any of aspects 1 to 17.

Aspect 19 is an apparatus for wireless communication including means for implementing any of aspects 1 to 17.

Aspect 20 is a computer-readable medium (e.g., a non-transitory computer-readable medium) storing computer executable code, the code when executed by at least one processor causes the at least one processor to implement any of aspects 1 to 17.

Aspect 21 is an apparatus for wireless communication at a device, including at least one memory and at least one processor coupled to the at least one memory and, based at least in part on information stored in the at least one memory, the at least one processor, individually or in any combination, is configured to: transmit, to a network entity, a request for a location of a network node associated with a set of cells, wherein each of the set of cells includes a cell identifier (ID), wherein the cell ID for each of the set of cells is associated with a node ID for the network node; and receive, from the network entity based on the request, an indication of the location of the network node associated with the set of cells, wherein the location of the network node is based on an average location of the set of cells.

Aspect 22 is the apparatus of aspect 21, wherein each of the set of cells is associated with a coverage area in a plurality of coverage areas, and wherein the location of each of the set of cells is based on the coverage area associated with each of the set of cells.

Aspect 23 is the apparatus of aspect 22, wherein the plurality of coverage areas is a plurality of sector centers, wherein the location of each of the set of cells is based on at least one sector center in the plurality of sector centers.

Aspect 24 is the apparatus of any of aspects 21 to 23, wherein the average location of the set of cells is based on a weighted average of the location of each of the set of cells or an unweighted average of the location of each of the set of cells.

Aspect 25 is the apparatus of aspect 24, wherein the weighted average of the location of each of the set of cells or the unweighted average of the location of each of the set of cells is based on a coverage area of each of the set of cells.

Aspect 26 is the apparatus of any of aspects 21 to 25, wherein a location of at least one cell is based on the average location of the set of cells, and wherein the at least one cell is at least one unknown cell associated with the set of cells.

Aspect 27 is the apparatus of aspect 26, wherein the at least one unknown cell is associated with the set of cells based on the node ID for the network node, and wherein the location of the at least one unknown cell and the location of the network node correspond to a database or a first memory.

Aspect 28 is the apparatus of any of aspects 21 to 27, wherein the location of the network node is associated with an uncertainty value corresponding to the average location of the set of cells.

Aspect 29 is the apparatus of any of aspects 21 to 28, wherein each of the set of cells is further associated with at least one of a mobile country code (MCC), a mobile network code (MNC), a physical cell ID (PCI), or a frequency.

Aspect 30 is the apparatus of any of aspects 21 to 29, wherein the cell ID for each of the set of cells corresponds to a database or a first memory, and wherein the location of each of the set of cells is based on the cell ID corresponding to the database or the first memory.

Aspect 31 is the apparatus of any of aspects 21 to 30, wherein the network entity is a server, a location server, a positioning server, a cloud server, an edge server, a network, or a location management function (LMF), wherein the network node is a base station or a transmission-reception point (TRP), and wherein each of the set of cells is within a coverage area of the base station or the TRP.

Aspect 32 is the apparatus of any of aspects 21 to 31, further comprising at least one of an antenna or a transceiver coupled to the at least one processor, wherein to receive the indication of the location of the network node, the at least one processor, individually or in any combination, is configured to: receive, via at least one of the antenna or a transceiver, the indication of the location of the network node.

Aspect 33 is the apparatus of any of aspects 21 to 32, where the apparatus is a wireless communication device, further including at least one of an antenna or a transceiver coupled to the at least one processor.

Aspect 34 is a method of wireless communication for implementing any of aspects 21 to 33.

Aspect 35 is an apparatus for wireless communication including means for implementing any of aspects 21 to 33.

Aspect 36 is a computer-readable medium (e.g., a non-transitory computer-readable medium) storing computer executable code, the code when executed by at least one processor causes the at least one processor to implement any of aspects 21 to 33.

What is claimed is:

1. An apparatus for wireless communication at a network entity, comprising:
at least one memory; and
at least one processor coupled to the at least one memory and, based at least in part on first information stored in the at least one memory, the at least one processor, individually or in any combination, is configured to:
detect a set of cells associated with a network node, wherein each of the set of cells includes a cell identifier (ID), wherein the cell ID for each of the set of cells is associated with a node ID for the network node;
identify a location of each of the set of cells based on the cell ID for each of the set of cells;
estimate an average location of the set of cells based on the location of each of the set of cells; and
calculate a location of the network node based on the average location of the set of cells.

2. The apparatus of claim 1, wherein the at least one processor, individually or in any combination, is further configured to:
output an indication of the location of the network node based on the calculation of the location of the network node.

3. The apparatus of claim 2, wherein to output the indication of the location of the network node, the at least one processor, individually or in any combination, is configured to:
transmit, for at least one device, the indication of the location of the network node; or
store, in a first memory or a cache, the indication of the location of the network node.

4. The apparatus of claim 1, wherein each of the set of cells is associated with a coverage area in a plurality of coverage areas, and wherein to identify the location of each of the set of cells, the at least one processor, individually or in combination, is configured to:
identify the location of each of the set of cells based on the coverage area associated with each of the set of cells.

5. The apparatus of claim 4, wherein the at least one processor, individually or in any combination, is further configured to:
crowdsource data for each of the set of cells associated with each of the plurality of coverage areas; and
determine a location of the coverage area for each of the set of cells based on the crowdsourced data, wherein to identify the location of each of the set of cells, the at least one processor, individually or in combination, is configured to: identify the location of each of the set of cells further based on the location of the coverage area.

6. The apparatus of claim 4, wherein the plurality of coverage areas is a plurality of sector centers, wherein to identify the location of each of the set of cells, the at least one processor, individually or in combination, is configured to: identify the location of each of the set of cells further based on at least one sector center in the plurality of sector centers.

7. The apparatus of claim 1, wherein to estimate the average location of the set of cells, the at least one processor, individually or in any combination, is configured to: average the location of each of the set of cells to obtain the average location of the set of cells.

8. The apparatus of claim 1, wherein the average location of the set of cells is based on a weighted average of the location of each of the set of cells or an unweighted average of the location of each of the set of cells.

9. The apparatus of claim 8, wherein the weighted average of the location of each of the set of cells or the unweighted average of the location of each of the set of cells is based on a coverage area of each of the set of cells.

10. The apparatus of claim 1, wherein the at least one processor, individually or in any combination, is further configured to:
receive, from at least one device, a request for the location of the network node prior to the detection of the set of cells associated with the network node; and
transmit, for the at least one device based on the request, an indication of the location of the network node after the calculation of the location of the network node.

11. The apparatus of claim 10, further comprising at least one of an antenna or a transceiver coupled to the at least one processor, wherein to transmit the indication of the location of the network node, the at least one processor, individually or in any combination, is configured to: transmit, via at least one of the antenna or the transceiver, the indication of the location of the network node.

12. The apparatus of claim 1, wherein the at least one processor, individually or in any combination, is further configured to:
calculate a location of at least one cell based on the average location of the set of cells, wherein the at least one cell is at least one unknown cell associated with the set of cells.

13. The apparatus of claim 12, wherein the at least one unknown cell is associated with the set of cells based on the node ID for the network node, and wherein the location of the at least one unknown cell and the location of the network node is configured to be stored in a database or a first memory.

14. The apparatus of claim 1, wherein the location of the network node is associated with an uncertainty value corresponding to the average location of the set of cells, and wherein each of the set of cells is further associated with at least one of a mobile country code (MCC), a mobile network code (MNC), a physical cell ID (PCI), or a frequency.

15. The apparatus of claim 1, wherein the cell ID for each of the set of cells is configured to be stored in a database or a first memory, and wherein to identify the location of each of the set of cells, the at least one processor, individually or in combination, is configured to: identify the location of each of the set of cells based on the cell ID that is configured to be stored in the database or the first memory.

16. The apparatus of claim 1, wherein the network entity is a server, a location server, a positioning server, a cloud server, an edge server, a network, or a location management function (LMF), wherein the network node is a base station or a transmission-reception point (TRP), and wherein each of the set of cells is within a coverage area of the base station or the TRP.

17. An apparatus for wireless communication at a device, comprising:
at least one memory; and
at least one processor coupled to the at least one memory and, based at least in part on first information stored in the at least one memory, the at least one processor, individually or in any combination, is configured to:
transmit, to a network entity, a request for a location of a network node associated with a set of cells, wherein each of the set of cells includes a cell identifier (ID), wherein the cell ID for each of the set of cells is associated with a node ID for the network node; and
receive, from the network entity based on the request, an indication of the location of the network node associated with the set of cells, wherein the location of the network node is based on an average location of the set of cells.

18. The apparatus of claim 17, wherein each of the set of cells is associated with a coverage area in a plurality of coverage areas, and wherein the location of each of the set of cells is based on the coverage area associated with each of the set of cells.

19. The apparatus of claim 18, wherein the plurality of coverage areas is a plurality of sector centers, wherein the location of each of the set of cells is based on at least one sector center in the plurality of sector centers.

20. The apparatus of claim 17, wherein the average location of the set of cells is based on a weighted average of the location of each of the set of cells or an unweighted average of the location of each of the set of cells.

21. The apparatus of claim 20, wherein the weighted average of the location of each of the set of cells or the unweighted average of the location of each of the set of cells is based on a coverage area of each of the set of cells.

22. The apparatus of claim 17, wherein a location of at least one cell is based on the average location of the set of cells, and wherein the at least one cell is at least one unknown cell associated with the set of cells.

23. The apparatus of claim 22, wherein the at least one unknown cell is associated with the set of cells based on the node ID for the network node, and wherein the location of the at least one unknown cell and the location of the network node correspond to a database or a first memory.

24. The apparatus of claim 17, wherein the location of the network node is associated with an uncertainty value corresponding to the average location of the set of cells.

25. The apparatus of claim 17, wherein each of the set of cells is further associated with at least one of a mobile country code (MCC), a mobile network code (MNC), a physical cell ID (PCI), or a frequency.

26. The apparatus of claim 17, wherein the cell ID for each of the set of cells corresponds to a database or a first memory, and wherein the location of each of the set of cells is based on the cell ID corresponding to the database or the first memory.

27. The apparatus of claim 17, wherein the network entity is a server, a location server, a positioning server, a cloud server, an edge server, a network, or a location management function (LMF), wherein the network node is a base station or a transmission-reception point (TRP), and wherein each of the set of cells is within a coverage area of the base station or the TRP.

28. The apparatus of claim 17, further comprising at least one of an antenna or a transceiver coupled to the at least one processor, wherein to receive the indication of the location of the network node, the at least one processor, individually or in any combination, is configured to: receive, via at least one of the antenna or the transceiver, the indication of the location of the network node.

29. A method of wireless communication at a network entity, comprising:
detecting a set of cells associated with a network node, wherein each of the set of cells includes a cell identifier (ID), wherein the cell ID for each of the set of cells is associated with a node ID for the network node;
identifying a location of each of the set of cells based on the cell ID for each of the set of cells;
estimating an average location of the set of cells based on the location of each of the set of cells; and
calculating a location of the network node based on the average location of the set of cells.

30. A method of wireless communication at a device, comprising:
transmitting, to a network entity, a request for a location of a network node associated with a set of cells, wherein each of the set of cells includes a cell identifier (ID), wherein the cell ID for each of the set of cells is associated with a node ID for the network node; and
receiving, from the network entity based on the request, an indication of the location of the network node associated with the set of cells, wherein the location of the network node is based on an average location of the set of cells.
